(19) United States
(12) Patent Application Publication
(10) Pub. No.: US 2026/0120189 A1
(43) Pub. Date: Apr. 30, 2026

(54) SYSTEMS, PRODUCTS, AND METHODS OF MANAGING ASSETS

(71) Applicant: Kevin R. MILLER, Bloomington, MN (US)

(72) Inventor: Kevin R. MILLER, Bloomington, MN (US)

(21) Appl. No.: 19/160,344

(22) PCT Filed: Apr. 1, 2024
(86) PCT No.: PCT/US2024/022534

§ 371 Date: Aug. 27, 2025

Related U.S. Application Data
(60) Provisional application No. 63/493,292, filed on Mar. 30, 2023.
(60) Provisional application No. 63/493,288, filed on Mar. 30, 2023.
(60) Provisional application No. 63/582,204, filed on Sep. 12, 2023.

(51) Int. Cl. G06Q 40/04

(52) U.S. Cl. CPC G06Q 40/054

(57) ABSTRACT

Systems, products, and methods of managing assets are described, each of which seeks to group assets into sleeves, and the asset sleeves are evaluated from time to time for the purpose of determining whether different assets would better serve an investor's goals. Over time, the mix of assets allocated to a sleeve is modified so that the risk-level of the sleeve decreases. Each of the sleeves has a different date on which the assets will be liquidated. Upon liquidation, the proceeds may be made available to the investor for spending on things such as living expenses.

### PRIORITY CLAIM

This application claims the benefit of priority to the following patent applications:
U.S. patent application Ser. No. 63/582,204 (filed 12 Sep. 2023);
U.S. patent application Ser. No. 63/493,288 (filed 30 Mar. 2023); and
U.S. patent application Ser. No. 63/493,292 (filed 30 Mar. 2023).

### INCORPORATION BY REFERENCE

The disclosures of the three patent applications referenced above are hereby incorporated into this document.

### FIELD OF THE INVENTION

The present invention relates to methods of managing assets, such as target-date funds, as well as systems and products for carrying out such methods.

### BACKGROUND OF THE INVENTION

Mutual fund management companies, such as Fidelity Investments (Boston, Massachusetts) and Vanguard (Malvern, Pennsylvania), offer so called “'target-date funds” (each a “TDFund”) as a way to attract money from individuals that do not have time to manage their money but have a need to fund a particular future purpose, such as retirement. TDFunds came into vogue during the early 2000s as a way to make investing for a future event (such as retirement) easy for some investors and advisors. For a TDFund having a particular target date, the management company selects assets (e.g. stocks and bonds) that the management company believes may be appropriate for the investors (as a group) that place money into a particular TDFund.

Target date funds are typically offered in five-year increments, e.g. 2025, 2030, 2035, 2040, 2045. Each investor is expected to select his/her target date fund based on the year in which he/she may need to convert an interest in the fund to a liquid asset (such as cash) or a near-liquid asset (such as treasury bills), for example upon retirement as a way to compensate for the cessation of income from employment.

Over time, the mix of assets held by the TDFund is adjusted by the management company according to what the management company deems appropriate for the investor-group as a whole. When the target date (i.e. liquidation date) is far away, management companies typically select the mix of assets for a particular TDFund to invest more of its assets in high growth/high volatility assets (such as stocks) and less in low growth/low volatility assets (such as bonds). Over time as the target date draws near, management companies typically adjust the mix of the TDFund's assets to gradually decrease the proportion invested in high growth/high volatility assets (such as stocks) and gradually increase the proportion invested in low growth/low volatility assets (such as bonds).

Example TDFund: As an example, if an investor plans to retire in 2025 that investor could choose a TDFund having a target date of 2025 and provide the management company with money to be invested in that 2025 TDFund. Then, the management company invests that individual's money in a manner that the management company believes is suitable for a typical person expecting to initiate spending their portion of the TDFund in 2025. As a result, the allocation of assets (e.g. stocks vs. bonds, or high yield vs. low risk assets) for each investor in the 2025 TDFund will be identical regardless of that particular investor's need for asset protection or asset accumulation.

Consequently, a TDFund having a particular target date may not be well suited for all investors having that target date because the risk-needs of investors in the fund are likely different. For example, some investors may not have saved sufficiently at the time of investing in a TDFund and thus need to increase the value of the investor's assets, which would typically be accomplished by investing in growth-oriented assets having higher volatility and/or higher risk. Other investors may have saved sufficiently at the time of investing in a TDFund, and thus need to protect more of their assets from loss or volatility. Similarly, all investors in a TDFund likely do not have the same risk-tolerance, and those risk-tolerances likely change with time. But, despite having investors in a TDFund who do not have the same risk-need and/or risk-tolerance, TDFund managers will not adjust the asset allocation of the TDFund to suit the risk-need or risk-tolerance of each investor. Such an inability to accommodate the needs and tolerances of each investor can lead to confusion and discontent among the investors in a particular TDFund.

Also, upon reaching the target date, each investor associated with a particular TDFund will have the same asset allocation. In other words, if the 2025 TDFund has 60% in bonds and 40% in stocks, an investor's liquidation of that investment will come 60% from bonds and 40% from stocks. In addition, once the target date is reached, the asset allocation of the TDFund will not change even though the individual investor may not need all of his/her investment on the target date-i.e. the investor likely has a need to convert his/her investment to cash over time, rather than all at once, and yet the asset-allocation will remain the same during the time that is after the target date. So, again a TDFund having a particular target date may not be well suited for all investors having that target date.

Another source of investor confusion and discontent arises when the investor's year of liquidation does not align with the 5-year increments offered by management companies, i.e., an investor may plan to begin liquidating their holdings in 2027, but most TDFunds identify target dates that either end in years that end in a 5 or a 0. Such an investors may become confused regarding whether they should invest in a 2025 TDFund or a 2030 TDFund.

In addition to the problems identified above, TDFunds are considered to be a defined contribution (i.e. deposit-based (a.k.a. “contribution based”)) investment concept wherein the amount of money being invested is known, but there are no outcome-based goals. For instance, if $100,000 is invested into a 2025 TDFund there are no outcome-based performance expectations for that money either in the number of planned payouts, the duration until payouts commence, and/or the amount of each planned payout. Instead, a TDFund is typically viewed by the fund managers as an asset gathering mechanism for the benefit of the company offering the TDFund, and with no guiding principles toward meeting any particular investor's future liquidation goals, needs, or demands. TDFunds simply collect assets and manage the funds based on the investment company's criteria, which may not incorporate or be fully in agreement with a particular investor's needs.

Lastly, the managers of a particular TDFund do not take into account an individual's expectations regarding how long the assets will be needed or the rate of spending that an individual is likely to have. Put simply, TDFunds are offered on a “one-size-fits-all” basis to investors that are of varying “sizes”, and as such, TDFunds do not properly serve the needs of many investors.

In addition, there are other problems with TDFunds. Investors having assets in a particular TDFund have no influence regarding the selection of assets initially, or how the mix of assets is adjusted over time. This lack of control by an individual investor, and the lack of attention to an individual's risk-needs and risk-tolerance make TDFunds a poor choice for many investors.

### SUMMARY OF THE INVENTION

The invention may be embodied as an asset management system for managing assets of an investor. Such a system may include:
an investor information database (“IIDatabase”) for storing information about an investor;
a processing apparatus comprising at least one non-transitory memory having computer-executable program code instructions stored thereon, and at least one processor capable of executing the program code instructions, wherein the processor, the at least one non-transitory memory, and the program code instructions are configured to cause the processing apparatus to:
   (A) receive information about the investor (“Investor Information”), including a conversion start date (“CSDate”) and a spend period;
      the CSDate being a date on which the investor would like to begin converting assets, which are managed by the management system, to liquid or near-liquid assets, and
      the spend period being a period of time starting on the CSDate and ending on a date that is later than the CSDate during which the investor would like assets to be available for conversion to the liquid or near-liquid assets;
   (B) store the Investor Information in the IIDatabase;
   (C) divide the spend-period into time-subsets;
   (D) for each time-subset:
      (i) identify an anticipated conversion date (“ACDate”), the ACDate being a date during the time-subset when assets associated with the time-subset are expected to be converted to the liquid or near-liquid assets;
      (ii) determine an amount of time between a current date and the ACDate (“Temporal Distance”);
      (iii) select a first risk value that is correlated to the determined Temporal Distance;
      (iv) identify an initial asset value (“IA Value”);
      (v) identify a first group of assets having the selected first risk value and the identified IA Value;
   (E) provide instructions to acquire assets;
   (F) allocate the acquired assets to sleeves of assets (each, a “Sleeve”), each Sleeve:
      (i) having the characteristics of one of the first groups; and
      (ii) being associated with the ACDate and time-subset corresponding to the one of the first groups;
   (G) identify an adjustment date on which the assets of at least one of the Sleeves will be evaluated for adjustment, and on the adjustment date for the Sleeve to be adjusted:
      (i) determine a new Temporal Distance for the time-subset corresponding to the Sleeve to be adjusted;
      (ii) select a new risk value (“New Risk Value”) for the time-subset corresponding to the Sleeve to be adjusted, the New Risk Value being correlated to the new Temporal Distance;
      (iii) identify a second group of assets having the New Risk Value and an equivalent value of the Sleeve to be adjusted;
      (iv) provide instructions to acquire the second group of assets;
      (v) associate the acquired second group of assets with the Sleeve to be adjusted, and disassociate the first group of assets from the Sleeve to be adjusted;
   (H) for each Sleeve, on or near the ACDate for that Sleeve, identify the second group of assets associated with that Sleeve for conversion a liquid or near-liquid asset.

In the asset management system, the processor, the at least one non-transitory memory, and the program code instructions may be configured to cause the processing apparatus to:
(A) receive a maximum risk tolerance of the investor;
(B) prior to identifying the first groups, modify the selected risk values that are higher than the maximum risk tolerance so that the selected risk values are not higher than the maximum risk tolerance.

In the asset management system, the processor, the at least one non-transitory memory, and the program code instructions may be configured to cause the processing apparatus to:
(A) receive a maximum risk tolerance of the invenstor;
(B) prior to identifying the second groups, modify the New Risk Values that are higher than the maximum risk tolerance so that the New Risk Values are not higher than the maximum risk tolerance.

In the asset management system, each risk value may be correlated with a range of time, and selection of the risk value may be carried out by determining which of the ranges the Temporal Distance falls within.

In the asset management system, the ranges may be set so that risk values that are high are correlated with ranges considered to be long (i.e. having times that are distant in the future) relative to ranges correlated to low risk values, and risk values that are low are correlated with ranges considered to be short (i.e. having times that are not distant in the future) relative to ranges correlated to high risk values. The determination regarding whether a range is long or short, may be made by a system administrator, the investor, or some other human being.

The asset management system may further include an asset definition database for storing information about assets that may be acquired, wherein the information about assets may include risk information for each of the assets that may be acquired.

In the asset management system, the IA Value may be a present value of an asset liquidation goal (“ALGoal”), the ALGoal being a desired value of assets associated with a time-subset when the ACDate of that time-subset is reached.

In the asset management system, each risk value may be associated with an anticipated rate-of-return, and the present value of the ALGoal may be determined by taking into account the anticipated rate-of-return for the risk value and the New Risk Value of the time-subset.

The asset management system may have an acquired-asset information database for storing information about the acquired assets.

In the asset management system, the risk value may be high if the asset is considered likely to have large changes in value over a time period.

In the asset management system, the risk value may be low if the asset is considered likely to have small changes in value over a time period.

In the asset management system, the computer-executable program code instructions further include instructions capable of causing the processor, on the adjustment date, to determine whether the first group of assets of the Sleeve achieved an expected growth, and delay executing step “G” (above) if the first group of assets of the Sleeve did not achieve the expected growth.

The invention may be embodied as a computer program product for managing assets, the computer program product comprising at least one non-transitory computer-readable storage medium having computer-executable program code instructions stored therein, the computer-executable program code instructions comprising program code instructions capable of causing a processing apparatus having at least one processor capable of executing the program code instructions to:
(A) receive information about the investor (“Investor Information”), including a conversion start date (“CSDate”) and a spend period;
   the CSDate being a date on which the investor would like to begin converting assets, which may be managed by using the computer program product, to liquid or near-liquid assets, and
   the spend period being a period of time starting on the CSDate and ending on a date that is later than the CSDate during which the investor would like assets to be available for conversion to the liquid or near-liquid assets;
(B) store the Investor Information in an investor information database;
(C) divide the spend-period into time-subsets;
(D) for each time-subset:
   (i) identify an anticipated conversion date (“ACDate”), the ACDate being a date during the time-subset when assets associated with the time-subset are expected to be converted to the liquid or near-liquid assets;
   (ii) determine an amount of time between a current date and the ACDate (“Temporal Distance”);
   (iii) select a first risk value that is correlated to the determined Temporal Distance;
   (iv) identify an initial asset value (“IA Value”);
   (v) identify a first group of assets having the selected first risk value and the identified IA Value;
(E) provide instructions to acquire assets;
(F) allocate the acquired assets to sleeves of assets (each, a “Sleeve”), each Sleeve:
   (i) having the characteristics of one of the first groups; and
   (ii) being associated with the ACDate and time-subset corresponding to the one of the first groups;
(G) identify an adjustment date on which the assets of at least one of the Sleeves will be evaluated for adjustment, and on the adjustment date for the Sleeve to be adjusted:
   (i) determine a new Temporal Distance for the time-subset corresponding to the Sleeve to be adjusted;
   (ii) select a new risk value (“New Risk Value”) for the time-subset corresponding to the Sleeve to be adjusted, the New Risk Value being correlated to the new Temporal Distance;
   (iii) identify a second group of assets having the New Risk Value and an equivalent value of the Sleeve to be adjusted;
   (iv) provide instructions to acquire the second group of assets;
   (v) associate the acquired second group of assets with the Sleeve to be adjusted, and disassociate the first group of assets from the Sleeve to be adjusted;
(H) for each Sleeve, on or near the ACDate for that Sleeve, identify the second group of assets associated with that Sleeve for conversion to a liquid or near-liquid asset.

With regard to the computer program product, processor, the at least one non-transitory memory, and the program code instructions may be configured to cause the processing apparatus to:
(a) receive a maximum risk tolerance of the investor;
(b) prior to identifying the first groups, modify the selected risk values that are higher than the maximum risk tolerance so that the selected risk values are not higher than the maximum risk tolerance.

With regard to the computer program product, the processor, the at least one non-transitory memory, and the program code instructions may be configured to cause the processing apparatus to:
(a) receive a maximum risk tolerance of the investor;
(b) prior to identifying the second groups, modify the New Risk Values that are higher than the maximum risk tolerance so that the New Risk Values are not higher than the maximum risk tolerance.

With regard to the computer program product, each risk value may be correlated with a range of time, and selection of the risk value may be carried out by determining which of the ranges the Temporal Distance falls within.

With regard to the computer program product, the ranges may be set so that risk values that are high are correlated with ranges having times that are distant in the future relative to ranges correlated to low risk values, and risk values that are low are correlated with ranges having times that are not distant in the future relative to ranges correlated to high risk values.

The computer program product may have computer-executable program code instructions capable of causing the processor to access an asset definition database that stores information about assets that may be acquired, wherein the information about assets includes risk information for each of the assets that may be acquired.

With regard to the computer program product, the IA Value may be a present value of an asset liquidation goal (“ALGoal”), the ALGoal being a desired value of assets associated with a time-subset when the ACDate of that time-subset is reached.

With regard to the computer program product, each risk value may be associated with an anticipated rate-of-return, and the present value of the ALGoal may be determined by taking into account the anticipated rate-of-return for the risk value and the New Risk Value of the time-subset.

The computer program product may have computer-executable program code instructions capable of causing the processor to send acquired-asset information to a database for storing information about the acquired assets.

With regard to the computer program product, the risk value may be high if the asset is considered likely to have large changes in value over a time period.

With regard to the computer program product, the risk value may be low if the asset is considered likely to have small changes in value over a time period.

The computer program product may have computer-executable program code instructions capable of causing the processor, on the adjustment date, to determine whether the first group of assets of the Sleeve achieved an expected growth, and delay executing step “G” if the first group of assets of the Sleeve did not achieve the expected growth.

The invention may be embodied as a computer-implemented method for managing assets, comprising:
providing an investor information database (“IIDatabase”) for storing information about an investor;
providing a processing apparatus comprising at least one non-transitory memory having computer-executable program code instructions stored thereon, and at least one processor capable of executing the program code instructions;
using the processor, the at least one non-transitory memory, and the program code instructions, causing the processing apparatus to:
   (A) receive information about the investor (“Investor Information”), including a conversion start date (“CSDate”) and a spend period;
      the CSDate being a date on which the investor would like to begin converting assets, which are managed by executing the computer-implemented method, to liquid or near-liquid assets, and
      the spend period being a period of time starting on the CSDate and ending on a date that is later than the CSDate during which the investor would like assets to be available for conversion to the liquid or near-liquid assets;
   (B) store the Investor Information in the IIDatabase;
   (C) divide the spend-period into time-subsets;
   (D) for each time-subset:
      (i) identify an anticipated conversion date (“ACDate”), the ACDate being a date during the time-subset when assets associated with the time-subset are expected to be converted to the liquid or near-liquid assets;
      (ii) determine an amount of time between a current date and the ACDate (“Temporal Distance”);
      (iii) select a first risk value that is correlated to the determined Temporal Distance;
      (iv) identify an initial asset value (“IAValue”);
      (v) identify a first group of assets having the selected first risk value and the identified IA Value;
   (E) provide instructions to acquire assets;
   (F) allocate the acquired assets to sleeves of assets (each, a “Sleeve”), each Sleeve:
      (i) having the characteristics of one of the first groups; and
      (ii) being associated with the ACDate and time-subset corresponding to the one of the first groups;
   (G) identify an adjustment date on which the assets of at least one of the Sleeves will be evaluated for adjustment, and on the adjustment date for the Sleeve to be adjusted:
      (i) determine a new Temporal Distance for the time-subset corresponding to the Sleeve to be adjusted;
      (ii) select a new risk value (“New Risk Value”) for the time-subset corresponding to the Sleeve to be adjusted, the New Risk Value being correlated to the new Temporal Distance;
      (iii) identify a second group of assets having the New Risk Value and an equivalent value of the Sleeve to be adjusted;
      (iv) provide instructions to acquire the second group of assets;
      (v) associate the acquired second group of assets with the Sleeve to be adjusted, and disassociate the first group of assets from the Sleeve to be adjusted;
   (H) for each Sleeve, on or near the ACDate for that Sleeve, identify the second group of assets associated with that Sleeve for conversion to a liquid or near-liquid asset.

With regard to the computer-implemented method, the processor, the at least one non-transitory memory, and the program code instructions may be configured to cause the processing apparatus to:
(i) Receive a maximum risk tolerance of the investor;
(ii) prior to identifying the first groups, modify the selected risk values that are higher than the maximum risk tolerance so that the selected risk values are not higher than the maximum risk tolerance.

With regard to the computer-implemented method, the processor, the at least one non-transitory memory, and the program code instructions may be configured to cause the processing apparatus to:
(i) receive a maximum risk tolerance of the investor;
(ii) prior to identifying the second groups, modify the New Risk Values that are higher than the maximum risk tolerance so that the New Risk Values are not higher than the maximum risk tolerance.

With regard to the computer-implemented method, each risk value may be correlated with a range of time, and selection of the risk value may be carried out by determining which of the ranges the Temporal Distance falls within.

With regard to the computer-implemented method, the ranges may be set so that risk values that are high are correlated with ranges having times that are distant in the future relative to ranges correlated to low risk values, and risk values that are low may be correlated with ranges having times that are not distant in the future relative to ranges correlated to high risk values.

The computer-implemented method may be carried out by accessing an asset definition database storing information about assets that may be acquired, wherein the information about assets includes risk information for each of the assets that may be acquired.

With regard to the computer-implemented method, the IAValue may be a present value of an asset liquidation goal (“ALGoal”), the ALGoal being a desired value of assets associated with a time-subset when the ACDate of that time-subset is reached.

With regard to the computer-implemented method, each risk value may be associated with an anticipated rate-of-return, and the present value of the ALGoal may be determined by taking into account the anticipated rate-of-return for the risk value and the New Risk Value of the time-subset.

The computer-implemented method may be carried out by storing information about acquired assets in an acquired-asset information database.

With regard to the computer-implemented method, the risk value may be high if the asset is considered likely to have large changes in value over a time period.

With regard to the computer-implemented method, the risk value may be low if the asset is considered likely to have small changes in value over a time period.

The computer-implemented method may be carried out so that the computer-executable program code instructions include and are used to cause the processing apparatus to determine whether the first group of assets of the Sleeve achieved an expected growth, and delay executing step “G” if the first group of assets of the Sleeve did not achieve the expected growth.

### BRIEF DESCRIPTION OF THE DRAWINGS

For a fuller understanding of the nature and objects of the invention, reference should be made to the accompanying drawings and the subsequent description. Briefly, the drawings are:

FIG. 1 is a flow chart depicting a method that is in keeping with the invention;

FIG. 2 is a flow chart depicting a method that is in keeping with the invention;

FIG. 3 is a flow chart depicting a method that is in keeping with the invention;

FIG. 4 is a flow chart depicting a method that is in keeping with the invention;

FIG. 5 is a schematic depiction of a system that is in keeping with the invention;

FIG. 6 depicts a graphical user interface in the form of an input screen that may be used with the invention;

FIG. 7A depicts a graphical user interface in the form of an input screen for an embodiment of the invention;

FIG. 7B depicts a graphical user interface in the form of the first of two output screens generated from the information shown in FIG. 7A;

FIG. 7C depicts a graphical user interface in the form of the second of two output screens generated from the information shown in FIG. 7A;

FIG. 8A depicts a graphical user interface in the form of an input screen for an embodiment of the invention;

FIG. 8B depicts a graphical user interface in the form of the first of two output screens generated from the information shown in FIG. 8A;

FIG. 8C depicts a graphical user interface in the form of the second of two output screens generated from the information shown in FIG. 8A;

FIG. 9A depicts a graphical user interface in the form of an input screen for an embodiment of the invention;

FIG. 9B depicts a graphical user interface in the form of the first of two output screens generated from the information shown in FIG. 9A;

FIG. 9C depicts a graphical user interface in the form of the second of two output screens generated from the information shown in FIG. 9A;

FIG. 10A depicts a graphical user interface in the form of an input screen for an embodiment of the invention;

FIG. 10B depicts a graphical user interface in the form of the first of two output screens generated from the information shown in FIG. 10A;

FIG. 10C depicts a graphical user interface in the form of the second of two output screens generated from the information shown in FIG. 10A;

FIG. 11A1, 11A2, and 11A3 depict a graphical user interface in the form of an input screen for an embodiment of the invention;

FIG. 11B depicts a graphical user interface in the form of the first of two output screens generated from the information shown in FIG. 11A1, 11A2, and 11A3;

FIG. 11C depicts a graphical user interface in the form of the second of two output screens generated from the information shown in FIG. 11A1, 11A2, and 11A3;

FIG. 12A depicts a graphical user interface in the form of an input screen for an embodiment of the invention;

FIG. 12B depicts a graphical user interface in the form of the first of two output screens generated from the information shown in FIG. 12A;

FIG. 12C depicts a graphical user interface in the form of the second of two output screens generated from the information shown in FIG. 12A;

FIG. 13A depicts a graphical user interface in the form of an input screen for an embodiment of the invention;

FIG. 13B depicts a graphical user interface in the form of the first of two output screens generated from the information shown in FIG. 13A;

FIG. 13C depicts a graphical user interface in the form of the second of two output screens generated from the information shown in FIG. 13A;

FIGS. 14A, 14A2, and 14A3 depict a graphical user interface in the form of an input screen for an embodiment of the invention;

FIG. 14B depicts a graphical user interface in the form of the first of two output screens generated from the information shown in FIG. 14A1, 14A2, and 14A3;

FIG. 14C depicts a graphical user interface in the form of the second of two output screens generated from the information shown in FIG. 14A1, 14A2, and 14A3;

FIG. 15A depicts a graphical user interface in the form of a graphical user interface in the form of an input screen for an embodiment of the invention;

FIG. 15B depicts the first of two output screens generated from the information shown in FIG. 15A;

FIG. 15C depicts the second of two output screens generated from the information shown in FIG. 15A.

### FURTHER DESCRIPTION OF THE INVENTION

The invention may be carried out as a method of managing assets. Such a method may be carried out and implemented with the assistance of a computer. In one embodiment of the invention, information may be obtained from an investor, and that information may be used to identify assets having desired characteristics, allocate the identified assets, and then manage those assets over time in a manner that takes into account that individual investor's needs and/or demands. As a starting point, some of the desired information may be obtained by collecting answers to the following questions:
Question 1. When (e.g. month and/or year) would the investor like to begin spending money derived from assets? The answer to Question 1 is referred to herein as the “Conversion Start Date”.
Question 2. After the Conversion Start Date, how long would the investor like assets to be available for conversion to a liquid asset or a near-liquid asset? The answer to Question 2 is referred to herein as the “Spend Period Duration”.
Question 3. What is the maximum risk tolerance of the investor with regard to the assets that will be acquired? The answer to Question 3 is referred to herein as the “Maximum Risk Tolerance”.

The answers to Question 1 and Question 2 may be used to identify a time period referred to herein as the “Spend-Period” during which the investor anticipates spending money obtained by converting the assets. Alternatively, Question 2 may be rephrased to request that the Spend-Period be identified. The Spend-Period starts on the Conversion Start Date and continues for the Spend Period Duration. A method carried out according to the invention may divide the Spend-Period into subsets (“Time-Subsets”), for example by identifying the years (or some other time-duration, e.g. quarters or months) over which the Spend-Period will occur.

### Sleeves

An asset portfolio may be identified and acquired for each of the Time-Subsets of the Spend-Period. For example, if the investor desires that assets are available for conversion to a liquid or near-liquid form during a 20-year Spend-Period, and if each Time-Subset is selected to be one year in duration, then 20 asset portfolios (each, a “Sleeve of Assets” or “sleeve” for short), one for each Time-Subset of the Spend-Period, may be identified and acquired. Each sleeve will have a different anticipated conversion date, which is the date on which the assets of a particular sleeve are anticipated to be converted to liquid or near-liquid assets (the “Anticipated Conversion Date”, or “ACDate” for short). Once assets are converted to liquid or near-liquid assets, it is anticipated the investor will use those assets as the investor pleases, for example, to cover living expenses.

Once assets are identified and acquired for each sleeve, those assets are allocated to the corresponding sleeve, and over time, the assets of a sleeve are managed and may be altered, for example, as described below. Each sleeve may be managed over time to achieve a particular rate-of-return, risk, and/or volatility, and the criteria guiding such management may change over time. In summary, for a particular sleeve, assets perceived to have the assigned characteristics for that sleeve (e.g. rate-of-return, risk, and/or volatility) are identified, acquired, and allocated to that sleeve.

### Asset Allocation

The investor's assets may be initially allocated to the sleeves via various methodologies. Among these methodologies are deposit-based (a.k.a. “contribution-based”) methodologies, and outcome-based methodologies. A deposit-based methodology allocates the investor's initial investment, and any subsequent investments, to the sleeves with little or no regard to the future needs of the investor during the Spend Period. For example, one deposit-based methodology allocates the investor's initial investment equally across the sleeves. In that situation, using Time-Subsets that are each one year in duration, an investor having $2,000,000 and requesting a Spend-Period of 20 years may result in identifying twenty Time-Subsets, each with $100,000 allocated to it. A deposit-based methodology may be a good choice for an investor that provides initial assets over time, for example in monthly or yearly installments.

The invention may use various methods of allocating the investor's initial investment, as well as ongoing investments, to the sleeves. Five such methods are:
1) Equal amounts—At the time made, an investment (initial or subsequent) may be allocated so that each sleeve receives the same value. To determine the value allocated to each sleeve, the investment value may be divided by the number of sleeves.
2) Offset for Future Inflation—An investment may be allocated to sleeves so that the anticipated or desired value of each sleeve on its ACDate is augmented to account for anticipated inflation. For example, if the anticipated annual inflation rate is 3.5% and the anticipated or desired value for each sleeve without inflation factored in is $100,000 and the ACDates are one year apart, then the anticipated or desired value of Sleeve #2 would be the value of Sleeve #1 plus a value equal to a 3.5% increase over the value of Sleeve #1. And similarly, the value of Sleeve #3 would be the value of Sleeve #2 augmented by a value equal to 3.5% increase over the value of Sleeve #2. And, such a process of increases over the value of the prior sleeve would be carried out until the adjusted value of the final sleeve is determined.
3) Phases-An investment may be allocated to sleeves so as to allow for individuals to separate their Spend Period Duration into phases. A phase may be defined by the number of sleeves, or the percentage of each investment to be allocated to each phase. For example, if an investor has $1,000,000 saved for retirement and prefers to split her retirement years into three phases, she may choose to spend 65% of her retirement assets during the first ten years of retirement, then spend 25% of her retirement assets during the next five years, and the remaining 10% of her assets the final three years. As a result of that investor's preferred split, 65% of that investor's $1,000,000 would be allocated to the first ten sleeves (i.e. $1,000,000×65%=$650,000) and if each sleeve is to receive an equal amount of that allocation, then $65,000 would be allocated to each of the ten sleeves. Similarly, the next five sleeves would be allocated 25% of the $1,000,000 ($1,000,000×25%=$250,000), and if allocated equally to those five sleeves, $50,000 ($250,000/5 yrs=$50,000) would be allocated to the next five sleeves. And finally, following the same methodology, $33,333 ($1,000,000×10%=$100,000/3 yrs=$33,333) would be allocated to the final three sleeves. This method of allocation allows an investor to “weight” their anticipated liquidation needs based on criteria such as other sources of income, longevity, anticipated activity during retirement years, and others.
4) Phases with Inflation Offset—An investment may be allocated to sleeves in a manner similar to the third methodology (above), but with the ability to take into account an anticipated inflation rate, for example in the manner outlined in the second methodology (above).
5) Varying Amounts—An investment may be allocated to sleeves by allowing the investor to specifically state the value he/she would like to allocate to each sleeve. These values can be manually entered via a computer or uploaded via a spreadsheet.

Whether obtained over time or as a lump sum, for a deposit-based methodology, the resulting sleeves are managed over time in an effort to achieve goals sought by the investor. For example, the investor's goals may include performance goals such as risk exposure and annualized return. Such goals may include investing the assets of a sleeve in a manner that associates a risk level with the “temporal distance”, the “temporal distance” being the time between the present date and the ACDate. For example, the mix of assets for each sleeve may be selected such that sleeves having a low temporal distance include more low risk assets than do sleeves having a high temporal distance. And, sleeves having a high temporal distance include more high risk assets than do sleeves having a low temporal distance. Management of each sleeve may be carried out so that periodically, the temporal distance of each sleeve is assessed, and then the mix of assets is adjusted from time to time in order to reduce the perceived risk of the mix of assets as the temporal distance of the sleeve decreases. For example, when a sleeve is initially created, a risk level may be assigned to that sleeve based on the sleeve's temporal distance, and then the assets for that sleeve are selected based on whether those assets are considered to be at or near that assigned risk level. Then, after some time has lapsed, the sleeve's temporal distance is assessed, a new risk level is selected such that the new risk level correlates to the current temporal distance, and the allocation of assets to the sleeve is modified (a “modified allocation of assets”) so that the resulting allocation of assets to the sleeve has the new risk level. In most situations, it is anticipated that the risk level will decrease as the temporal distance decreases.

To accomplish such a modified allocation of assets, risk levels may be identified and each risk level may be correlated to a range of possible temporal distances. When the new temporal distance is identified, that risk level corresponding to the new temporal distance may be selected. In addition, a list of possible assets may be provided in which each asset has been assigned a risk level. When a risk level is identified for a sleeve, either initially or after the passage of time, the list of assets may be consulted and assets having the identified risk level may be acquired, and then allocated to the sleeve that has been associated with that level of risk.

By combining the investment holdings allocated to each sleeve, an Aggregate Portfolio Allocation (APA) may be obtained for the investor's total account. The APA may be automatically generated and systematically updated (e.g. on a monthly basis) as time passes and the risk level for each sleeve changes in relation to its decreasing temporal distance. When a sleeve's temporal distance has decreased to the extent that a new (lower) risk level is identified, the overall APA may be adjusted accordingly. However, the investments allocated to each sleeve may be required to meet, or exceed, the assigned Default Projected Return (DPR) for that investment prior to transitioning into a lower risk investment. This will prohibit the transitioning of assets into a lower risk investment during a period of substantial losses in the existing allocation of assets. For instance, if the DPR of the assets allocated to a sleeve is 5%, yet when the time arrives to transition into a lower risk investment the actual annualized return for those assets has been 4.25%, the method may be carried out to continue to hold the assets in the existing investment until that investment's annualized return is 5%, or greater, at which time the assets of that sleeve may be transitioned into assets that have a lower risk.

An outcome-based methodology allocates the investor's initial assets to the sleeves based on the dollar amount desired when each sleeve reaches its ACDate. That desired dollar amount is referred to herein as the Asset Liquidation Goal (“ALGoal”). For example, if an investor wants to withdraw $100,000 per year following the investor's retirement date, then the ALGoal of that investor is $100,000 per year.

A method according to the invention that uses an outcome-based methodology might be implemented to identify sleeves and the associated ACDates, and a risk level may be assigned to each sleeve based on the sleeve's temporal distance. For each risk level, a corresponding expected rate-of-return can be identified (i.e. the DPR), and then the present value for each sleeve is determined. Those determined present values are the present values of the assets that should be allocated to each sleeve so that each sleeve will (hopefully) have a value equal to or exceeding the ALGoal (e.g. $100,000) when that sleeve's ACDate arrives. Then for each sleeve, assets are selected and acquired in an amount equal to the determined present value based on whether they are considered to be at or near the risk level assigned to that sleeve.

As an example of an outcome-based methodology, if the investor is two years away from retirement, then for that sleeve having an ACDate in two years, a risk level is assigned that is in keeping with the ACDate, and a rate-of-return corresponding to that risk level is used to determine a present value of the assets to be allocated to that sleeve in order that the ALGoal (e.g. $100,000) is achieved in two years. Similarly, the method could be carried out in order to determine the present value of assets for the sleeve that has an ACDate in three years, and so on until a present-value has been determined for each sleeve of the Spend-Period. The risk level assigned to each sleeve may be carried out so that the investor's Maximum Risk Tolerance is not exceeded. In summary, for an outcome-based implementation of a method according to the invention, for each sleeve, the ACDate is determined, a risk level is assigned that is in keeping with the temporal distance corresponding to the ACDate, the investor's desired ALGoal is determined, and then the present value of the assets that is expected to provide that ALGoal (the desired future asset value) is determined by using an anticipated rate-of-return for the assigned risk level. That present value for each sleeve represents the amount of money the investor needs to provide initially in order to achieve the ALGoal.

The present value may be determined by not only taking into account the initial assigned risk level and its corresponding expected rate-of-return, but also by taking into account the anticipated adjustments to a sleeve's risk level (and therefore, the expected rate-of-return), which will occur from time to time along with the passage of time. For example, for a particular sleeve having an ACDate that is initially 12 years away, the initial mix of assets may be expected to be at a high rate-of-return for three years, a moderate rate-of-return for 7 years, and a low rate-of-return for two years, and the present value determination would be carried out in order to reflect the amount of time assets are held at each rate-of-return.

Generally speaking, carrying out a method according to the invention will:
(a) determine the amount of time between (i) the day the investor makes assets available for investment, and (ii) the ACDate for a sleeve (the temporal distance);
(b) assign a risk level to each sleeve that corresponds to the temporal distance;
(c) allocate a portion of the investor's initial assets to each sleeve (whether the investor provides those initial assets as a lump sum or over time);
(d) acquire assets (e.g. stocks and/or bonds) that are in keeping with the assigned risk level.
   In a deposit-based methodology, once the initial assets are associated with the Time-Subsets, the initial allocated assets are used to acquire assets (e.g. stocks and/or bonds), and the acquired assets for each sleeve may be managed in a manner that is described below. In an outcome-based methodology, once the initial assets are associated with the Time-Subsets, the initial assets are used to acquire assets (e.g. stocks and/or bonds), and the acquired assets for each sleeve are managed in a manner that is believed will achieve or exceed the sleeve's ALGoal on that sleeve's ACDate, some of which are described below.

### Asset Management

Once the initial assets (e.g. cash) have been allocated to sleeves, those initial assets may be used to acquire assets (stocks and/or bonds) that are allocated to that sleeve. The selection of those acquired assets and their subsequent management may be accomplished by considering the ACDate and the investor's risk tolerance. For example, one such management methodology involves acquiring assets and allocating them to the sleeves such that:
(a) a sleeve having an ACDate that is distant from the present date has a higher percentage of assets that are identified as high risk (and therefore, potentially high growth), than will a sleeve having an ACDate that is nearer in time to the present date; and
(b) a sleeve having an ACDate that is nearer in time to the present date will have a higher percentage of assets that are identified as low risk (and therefore, potentially low growth), than will a sleeve having an ACDate that is further in time from the present date.
   In this manner, comparing sleeve to sleeve, the percentage of assets that are high risk increases with the temporal distance between the present date and the ACDate, and the percentage of assets that are low risk increases inversely with the temporal distance between the present date and the ACDate.

To illustrate this idea, for an investor desiring to retire in three years (the present date plus (“PD+”) three years), the assets allocated to the sleeve having an ACDate that is PD+3 years may be invested in assets having relatively low risk, whereas the assets allocated to the sleeve having an ACDate that is PD+23 years would be invested in assets having relatively high risk. As an ACDate for a particular sleeve approaches, the method may be carried out to instruct that the mix of assets (e.g. stocks and bonds) allocated to that sleeve be modified to a less risky mix of assets than were previously selected for that sleeve. A similar process may occur for each of the sleeves, whereby the mix of assets allocated to each sleeve may be modified over time to become less risky as the ACDate for that sleeve becomes closer to the current date. In practice, a method according to the invention may be carried out to determine an overall allocation between types of assets (high risk vs. low risk) for an investor's entire portfolio (the “Aggregate Portfolio”), and as time progresses, the Aggregate Portfolio is adjusted to reflect changes to be made to the allocation of assets for each sleeve.

The investor's Maximum Risk Tolerance may be incorporated into a method carried out according to the invention. For example, when considering a sleeve's ACDate and the corresponding temporal distance, the risk level corresponding to that temporal distance may be compared to the investor's Maximum Risk Tolerance. If the risk level corresponding to the temporal distance is greater than the Maximum Risk Tolerance, the sleeve's assigned risk level will be the Maximum Risk Tolerance. However, if the risk level corresponding to the temporal distance is not greater than the Maximum Risk Tolerance, the sleeve's assigned risk level will be the risk level corresponding to the temporal distance.

As such, a method according to the invention may assign to each sleeve a risk level that corresponds to the temporal distance, unless that assigned risk level exceeds the Maximum Risk Tolerance, in which case the assigned risk level is the Maximum Risk Tolerance. The resulting asset portfolio for each sleeve should be that those sleeves having a large temporal distance will be associated with the riskiest mix of investments, and those sleeves having a small temporal distance will be associated with the safest mix of investments. Said differently, assets acquired and associated with sleeves having ACDates that are closer to the present date may have relatively less risk than sleeves having ACDates that are further from the present date, and a sleeve that has an ACDate closest to the present date may have assets acquired and associated with it that have the lowest risk of all the sleeves. For example, the initially acquired assets corresponding to the sleeve having an ACDate that is furthest from the present date (in the example, above, the sleeve having an ACDate that is PD+23), may be selected based on the investor's Maximum Risk Tolerance, as indicated by the answer to Question 3 (above). If the investor's Maximum Risk Tolerance is identified as “moderate”, then the initial mix of acquired assets corresponding to the PD+23 sleeve may be moderately risky, and thus having a moderate expected rate-of-return relative to other available assets. As time progresses and the ACDate becomes closer to the present date, the mix of assets associated with the sleeve originally known as PD+23 may be adjusted to become less risky over time.

A similar process could occur for each of the other sleeves of assets, except that the initial mix of assets associated with the sleeves having an ACDate that is not the furthest from the present date may be (generally speaking) less risky than the mix of assets associated with the sleeve having an ACDate that is furthest from the present date. To illustrate the point, the initial mix of assets associated with the sleeve having an ACDate that is PD+8 years may be selected to be riskier and capable of more growth than the initial mix of assets associated with the sleeve having an ACDate that is PD+7 years, but the PD+8 year sleeve may have initial assets that are less risky and capable of less growth than the initial assets associated with the sleeve having an anticipated conversion date that is PD+9 years. If one were to consider the entire asset portfolio, the risk level of the initial assets corresponding to each sleeve could increase along with the temporal distance between the present date and the ACDate. Using the example above, the mix of assets initially associated with the PD+23 sleeve would be the riskiest mix of assets, and the mix of assets initially associated with the PD+3 sleeve would be the safest mix of assets. And, over time, the mix of assets associated with each sleeve may be periodically adjusted to become less risky, and so the method may be carried out so that the mix of assets for a particular sleeve at any point in time will have a risk level that is greater than sleeves having a smaller temporal distance, and that risk level will be less than sleeves having a larger temporal distance.

With regard to efforts to adjust the mix of assets associated with each sleeve over time, a method according to the invention may be implemented to use a projected default rate-of-return, and this projected rate-of-return may be used to determine when a sleeve's mix of investments should be transitioned to a lower risk. In one such embodiment of the invention, if the default rate-of-return for a mix of assets labeled as “moderate” risk is 5%, the method may be implemented so that an adjustment of sleeve's mix of assets from “moderate” to a less risky mix of assets does not occur until the assets associated with that sleeve achieve or exceed the 5% target. If the assets associated with a sleeve identified as “moderate” for a particular time period has not generated default rate-of-return (e.g. 5%) when it is time for a transition to a less risky mix of assets, the method may be carried out to suggest holding the existing assets (or similar assets identified as “moderate” risk) until the desired 5% return has been obtained. By doing so, the investor may be protected from having his/her assets transferred into a lower risk investment at a time when the markets could be going through a down-cycle.

### Additional Details

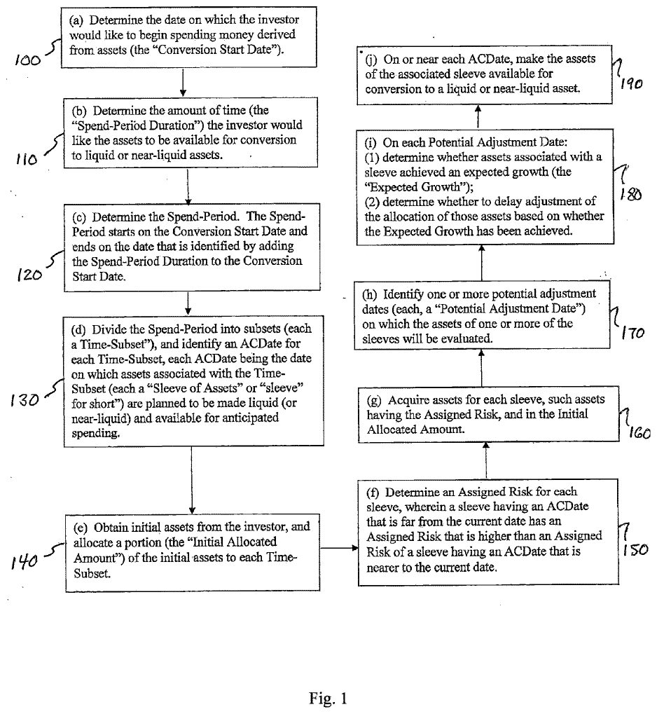

Having provided an overview of methods that are in keeping with the invention, additional details will now be provided with the assistance of FIGS. 1, 2, 3, and 4.

FIG. 1 is a flow chart depicting a method of managing assets that is in keeping with the invention. FIG. 1 identifies a method that employs a deposit-based methodology of asset allocation. Such a method may be carried out by executing the following steps:
(a) determine 100 the date (e.g. month and/or year) of the Conversion Start Date;
(b) determine the Spend-Period Duration 110 and the Spend-Period 120;
(c) divide 130 the Spend-Period into Time-Subsets;
(d) identify 130 an ACDate for each Time-Subset, and associate each ACDate with a different sleeve to which acquired assets will be allocated;
(e) determine 150 an Assigned Risk for each sleeve, each Assigned Risk being correlated to the amount of time between the current date and the sleeve's ACDate. For a sleeve having an ACDate that is far (i.e. temporally distant) from the current date, the Assigned Risk may be higher than an Assigned Risk of a sleeve having an ACDate that is nearer (i.e. temporally close) to the current date;
(f) for each sleeve, acquire 160 assets (e.g. stocks and/or bonds), such assets collectively having the Assigned Risk for that sleeve;
(g) identify 170 one or more potential adjustment dates on which the mix of assets in one or more of the sleeves will be evaluated;
(h) on each potential adjustment date:
   (1) determine 180 whether the mix of assets allocated to a sleeve achieved an expected growth;
   (2) determine 180 whether to delay adjustment of that mix of assets based on whether the expected growth has been achieved. If that mix of assets achieved the expected growth, then adjust the mix of assets (buy and sell assets) to achieve a lower-risk mix of assets. But, if that mix of assets did not achieve the expected growth, then delay adjustment of the mix of assets to a lower-risk mix of assets;
(j) on or near each ACDate, make 190 the assets of the corresponding sleeve available for conversion to a liquid or near-liquid asset.

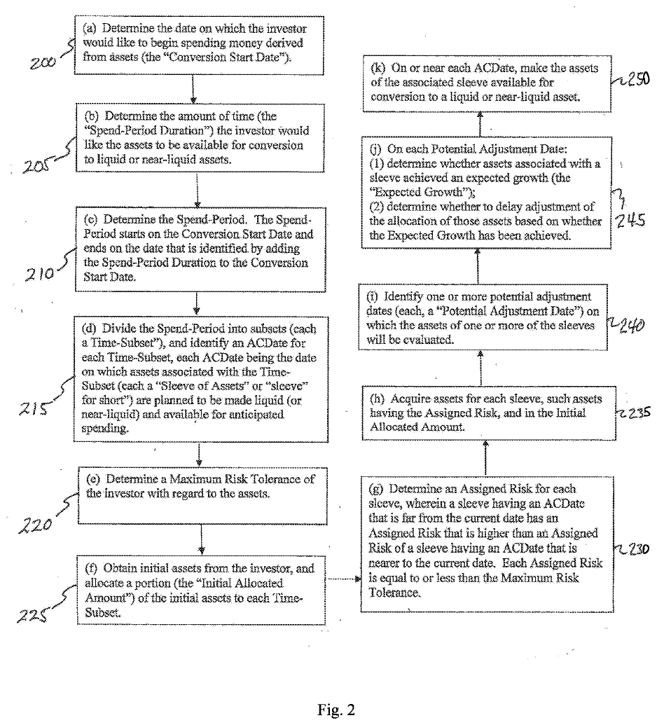

FIG. 2 depicts steps of a method that is similar to FIG. 1, and includes taking into account 220, 230 the investor's maximum risk tolerance. The maximum risk tolerance may be used to prevent any of the Assigned Risks from being higher than the investor's maximum risk tolerance.

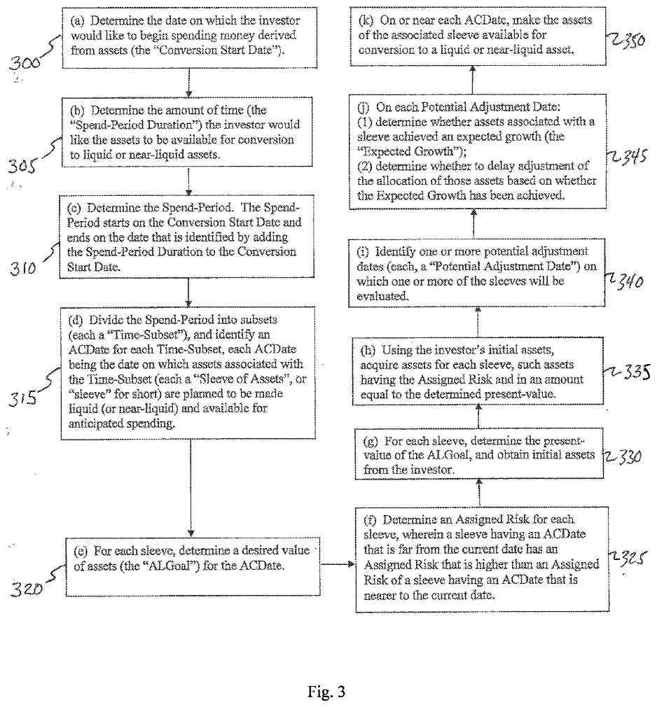

FIG. 3 is a flow chart depicting a method of managing assets that is in keeping with the invention. FIG. 3 identifies a method that employs an outcome-based methodology of asset allocation. Such a method may be carried out by executing the following steps:
(a) determine 300 the date (e.g. month and/or year) of the Conversion Start Date;
(b) determine the Spend-Period Duration 305 and the Spend-Period 310;
(c) divide 315 the Spend-Period into Time-Subsets;
(d) identify 315 an ACDate for each Time-Subset, and associate each ACDate with a different sleeve to which acquired assets will be allocated;
(e) for each sleeve, determine 320 a desired value of assets (the “ALGoal”) for the ACDate;
(f) determine 325 an Assigned Risk for each sleeve, each Assigned Risk being correlated to the amount of time between the current date and the sleeve's ACDate. For a sleeve having an ACDate that is far (i.e. temporally distant) from the current date, the Assigned Risk may be higher than an Assigned Risk of a sleeve having an ACDate that is nearer (i.e. temporally close) to the current date;
(g) for each sleeve, determine 330 the present-value of the ALGoal;
(h) for each sleeve, acquire 335 assets (e.g. stocks and/or bonds), such assets collectively having the Assigned Risk for that sleeve in the amount of the determined present-value;
(i) identify 340 one or more potential adjustment dates on which the mix of assets in one or more of the sleeves will be evaluated;
(j) on each potential adjustment date:
   (1) determine 345 whether the mix of assets allocated to a sleeve achieved an expected growth;
   (2) determine 345 whether to delay adjustment of that mix of assets based on whether the expected growth has been achieved. If that mix of assets achieved the expected growth, then adjust the mix of assets (buy and sell assets) to achieve a lower-risk mix of assets. But, if that mix of assets did not achieve the expected growth, then delay adjustment of the mix of assets to a lower-risk mix of assets;
(k) on or near each ACDate, make 350 the assets of the corresponding sleeve available for conversion to a liquid or near-liquid asset.

Regarding Step “e” of FIG. 3, the ALGoal for each sleeve may be determined via a number of techniques. Below are five such techniques:
1) Identify the ALGoal for one of the sleeves (e.g. Sleeve #1) and assign that amount to each sleeve. The identified ALGoal may be selected to be an amount of money believed to be equal to or greater than the investor's future living expenses;
2) Identify the ALGoal for the sleeve having the earliest ACDate (“Sleeve #1”), then for each subsequent sleeve, increase the ALGoal by a predetermined percentage in order to offset the potential impact of future inflation. That predetermined percentage may be selected by considering rates of inflation for prior years, and adjusting that percentage to take into account whether prior years are predictive of the future rate of inflation. The identified ALGoal may be selected to be an amount of money believed to be equal to or greater than the investor's future living expenses;
3) Identify a number of ALGoals and assign those amounts to the sleeves. This technique might be used when the investor predicts a desire to have money available, but the amount varies over time. For example, in addition to desiring to have an amount of money believed to be equal to or greater than the investor's normal living expenses, the investor may want to have more money every three years to accommodate a vacation trip every three years. Or, the investor may want to have more money during certain periods until Social Security Benefits or pension benefits are received, thereby allowing the adjustment of each ALGoal accordingly.
4) Maximize the ALGoals throughout the Spend Period given a specified initial investment value. For example, an investor may have $1,250,000 saved for retirement and would like to know the maximum annual amount that $1,250,000 could generate in the form of equal ALGoals over a predetermined Spend Period (e.g. 20 years beginning 15 years from now). The method may utilize¹ the inputs along with the Maximum Risk Tolerance to arrive at an ALGoal for each ACDate throughout the Spend Period Duration.
5) Maximize the ALGoals (similar “4” above), however instead of stipulating equal ALGoals across the Spend Period, the method could be carried out to increase the ALGoals by a predetermined percentage in order to offset the potential impact of future inflation. In such a method, each ALGoal will increase based on the anticipated inflation rate selected.

Regarding Step “g”, the present-value may be determined by considering the risk levels that will be assigned to a sleeve during the time period between the present date and that sleeve's ACDate, and the amount of time that each risk level is expected to be imposed on that sleeve. In addition, the present-value may be determined by taking into account an expected rate of inflation. ¹ How would the inputs be utilized to determine the maximum annual liquidation amount? What is the process that would be followed? For example, is it an iterative approach, and if so, how should that approach begin?

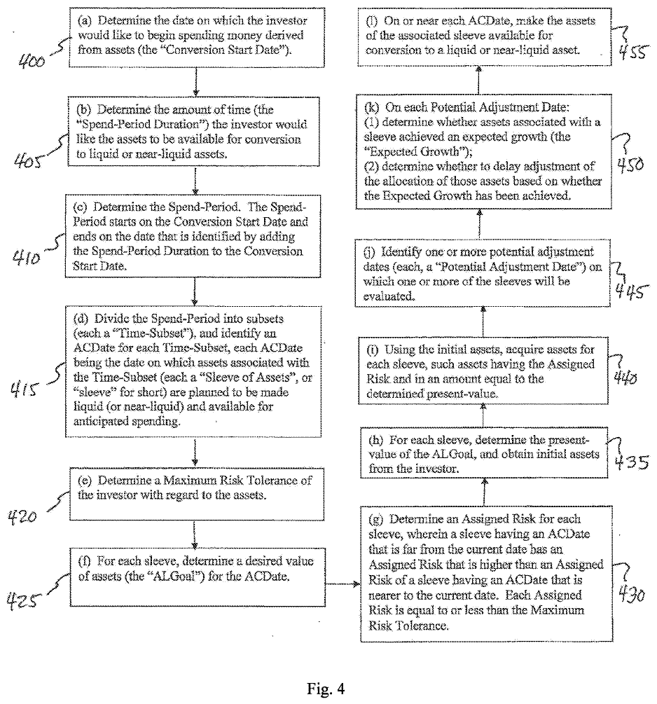

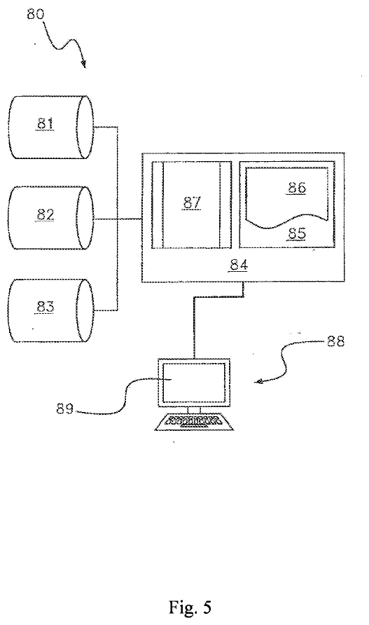

FIG. 4 depicts steps of a method that is similar to FIG. 3, and includes taking into account the investor's maximum risk tolerance. The maximum risk tolerance may be used to prevent any of the Assigned Risks from being higher than the investor's maximum risk tolerance.

From time to time, it may be desired to determine whether previously established criteria (e.g., Conversion Start Date, one or more ACDates, one or more ALGoals, Spend-Period, Maximum Risk Tolerance, etc.) should be modified, and if so, then that criteria would be modified, and the method carried out according to those altered criteria.

Also, a method according to the invention may be implemented to allow adjustments to the holding period for each type of risk level (e.g. high risk, medium risk, low risk) so that each sleeve can be more closely aligned with the investor's volatility temperament. This ability to customize allows the investor to adjust the duration that their assets may be held in each investment phase in order to match the investor's desired growth or asset protection, as the case may be. For instance, the default setting for a holding period of the lowest risk/lowest yielding investment may be to have assets invested in low-risk assets two years prior to the ACDate of each sleeve. However, the investor could choose a more abbreviated holding period (e.g. 1 year, or less) at the low-risk level, thereby allowing more time for potential growth believed to be possible with assets identified as having a higher risk-level. Or, a more extended holding period (3+years) may be selected for that period of time prior to the ACDate to provide for a longer duration geared toward asset protection. Likewise, the holding period at a particular risk-level (e.g. high risk, medium risk, low risk) can be set to zero, thereby completely forgoing a particular type of asset-class in order to meet individual desires of an investor.

In addition, adjustments to criteria may be undertaken to accommodate changing situations involving the investor. For example, if the investor initially indicates a desire to have a Spend-Period of 20 years that starts 10 years from now, but after acquiring and allocating assets to a sleeve, the investor learns of a health issue that will significantly reduce the investor's life-expectancy, then an adjustment may be made in order to reduce the Spend-Period and/or alter the Conversion Start Date. In response, a method according to the invention would allocate the existing assets across an updated number of sleeves corresponding to the shorter Spend-Period, earlier Conversion Start Date, and/or could also take into account a modified Maximum Risk Tolerance. The resulting guidance corresponding to the mix of assets allocated to each of the newly identified sleeves may be provided so that actions could be taken to manage the existing assets accordingly, thereby aligning the investor's asset allocations to better match the investor's modified Spend-Period, Conversion Start Date, and/or modified Maximum Risk Tolerance.

Finally, a method according to the invention may be carried out so as to indicate a probability of achieving a successful outcome. In one such embodiment of the invention, the present-value amounts determined in step “(g)” of FIG. 3 may be summed to obtain a cumulative present value (the “CPV”) amount. The CPV amount may be deemed to represent the amount that the investor will need to invest today in order to achieve the ALGoal for each sleeve in a timely manner (i.e. at the ACDate for each sleeve), given the predicted performance of the assets in each sleeve. Once the original CPV is determined, a method according to the invention may be carried out so as to identify levels of probability above the CPV (e.g. “More Probable”, “High Probability”, and “Very High Probability”), which identify initial investment amounts that are more likely to result in the ALGoal. Similarly, a method according to the invention may be carried out so as to identify levels of probability below the CPV (e.g. “Less Probable”, “Low Probability”, and “Very Low Probability”), which identify initial investment amounts that are less likely to result in the ALGoal. These probability levels may be used to guide the investor with making a decision about how much to invest.

The initial investment amounts to be associated with each probability level may be selected based on an algorithm or may be selected by an investment professional. For example, the CPV may be increased by a predetermined amount (e.g. 15%), and that amount may be identified as an amount that is “More Probable” to yield the ALGoal for each sleeve in a timely manner. An amount that is a predetermined amount more (e.g. 30%) than the CPV amount may be identified as an amount that has a “High Probability” of yielding the ALGoal for each sleeve in a timely manner. And, an amount that is a predetermined amount more (e.g. 45% more) than the CPV amount may be identified as an amount that has a “Very High Probability” of yielding the ALGoal for each sleeve in a timely manner.

Similarly, the CPV may be decreased by a predetermined amount (e.g. 15%), and that amount may be identified as an amount that is “Less Probable” to yield the ALGoal for each sleeve in a timely manner. An amount that is a predetermined amount less (e.g. 30%) than the CPV amount may be identified as an amount that has a “Low Probability” of yielding the ALGoal for each sleeve in a timely manner. And, an amount that is a predetermined amount less (e.g. 45%) than the CPV amount may be identified as an amount that has a “Very Low Probability” of yielding the ALGoal for each sleeve in a timely manner.

### Asset Management System

Having provided a general overview of methods that are in keeping with the invention, systems for carrying out such methods are now described. FIG. 5 depicts one such asset management system that is in keeping with the invention.

FIG. 5 depicts an asset management system 80 that is in keeping with the invention. Asset management system 80 may comprise an asset definition database 81 for storing asset-definition information, an investor-information database 82 for storing investor information, an acquired-asset information database 83 for storing acquired-asset information, and a processing apparatus 84 comprising at least one non-transitory memory 85 having computer-executable program code instructions 86 stored thereon, and at least one processor 87 capable of executing the program code instructions 86. The processor 87, the at least one non-transitory memory 85, and the program code instructions 86 may be configured to cause the processing apparatus 84 to carry out steps of a method, such as one of the methods outlined above, which may include enabling a human being (herein, a “Participant”), such as the investor or a financial advisor, to interact with the management system 80 via a graphical user interface (GUI) 89 displayed on a monitor/display of a Participant's device 88 (such as a cell phone or computer controlled by a Participant), the GUI being configured by a system-organizer to provide configuration information to Participants, and enable Participants to interact with the participant device 88; receive configuration information provided by the system organizer via a device associated with the system organizer (such as a computer controlled by the organizer); and store the configuration information in the definition database 81. It should be noted that, in some embodiments, the Participant's device 88 may comprise all or a portion of processing apparatus 84.

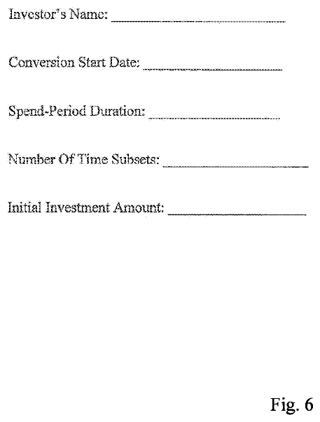

The configuration information may be provided via the GUI 89 to Participants as a fillable form having text that prompts a Participant to enter information needed to provide asset management. One such fillable form is depicted in FIG. 6.

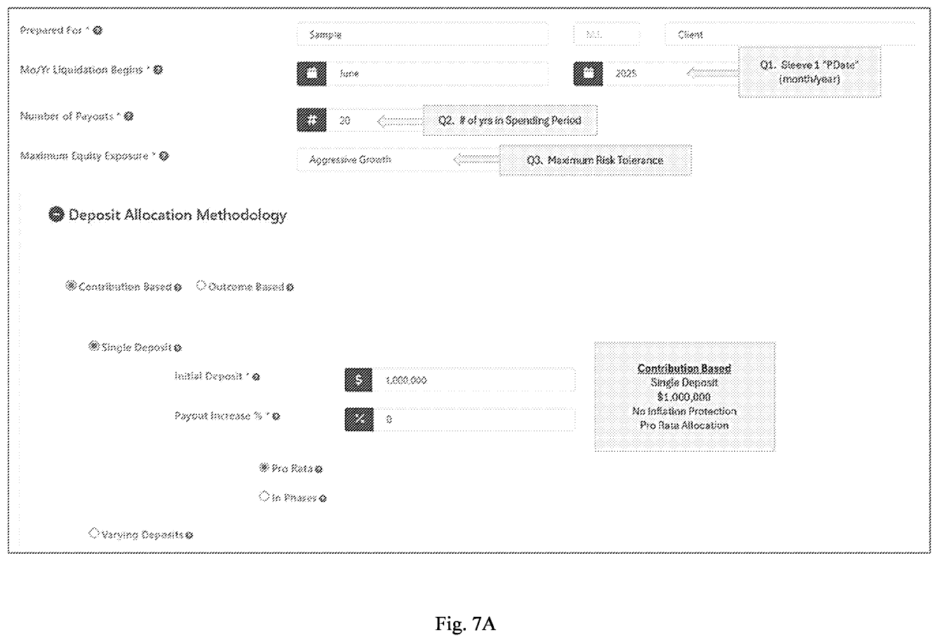

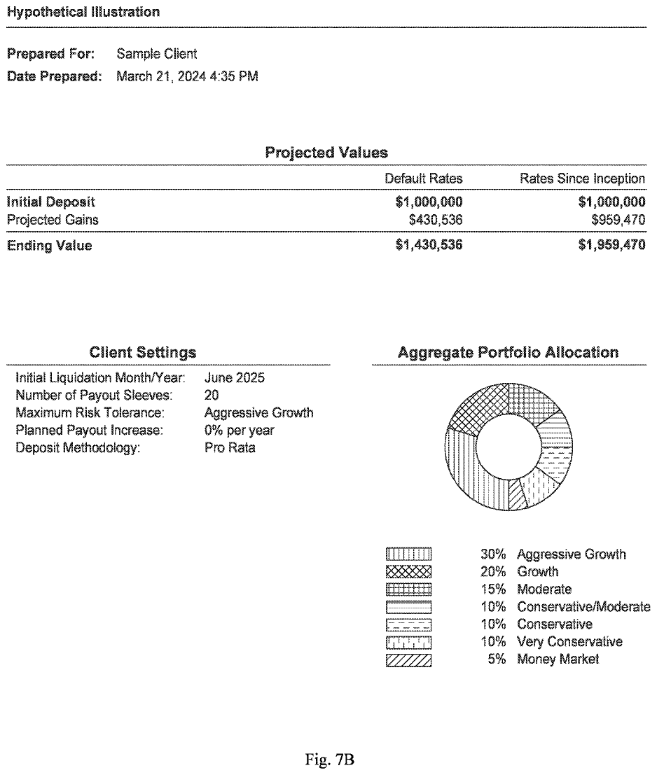

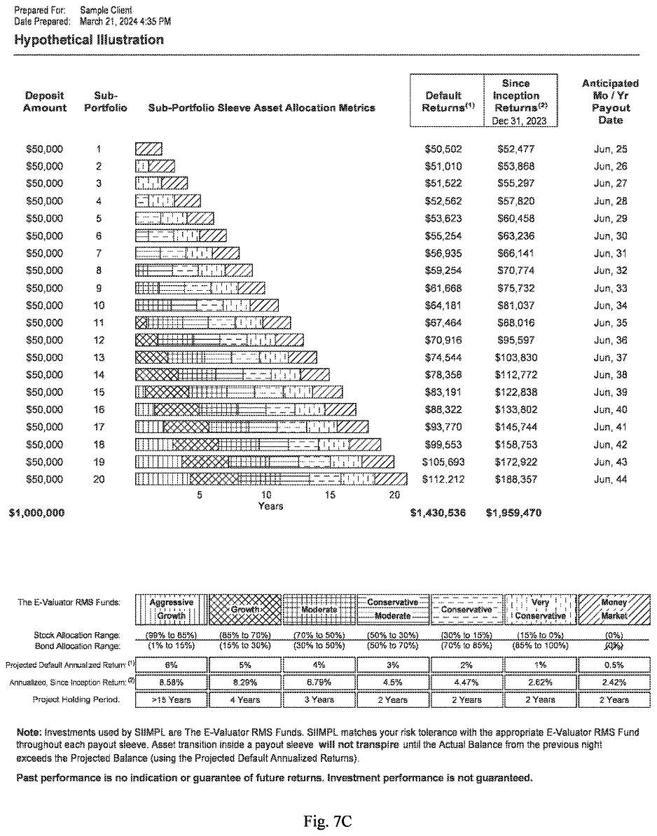

FIG. 7A depicts an input screen for an embodiment of the invention in which an initial deposit amount of one-million dollars allocated equally (“Pro Rata”) to each of 20 sleeves has been indicated. Also indicated is that the first sleeve has an ACDate of June 2025, and the maximum risk tolerance is identified as “Aggressive Growth”. No offset for inflation is indicated. FIG. 7B depicts the first of two output reports generated from the information shown in FIG. 7A. FIG. 7B indicates the projected gains and ending value of the assets using a default rate and also using historical rates for the assets selected. Also indicated in FIG. 7B is the allocation of the assets to seven risk categories as of the date of this report. FIG. 7C depicts the second of two output reports generated from the information shown in FIG. 7A. FIG. 7C indicates the deposit amount and the expected resulting value for each of the 20 sleeves. Two resulting values are indicated for each sleeve, one using a default rate of return, and another using historical rates for the assets selected.

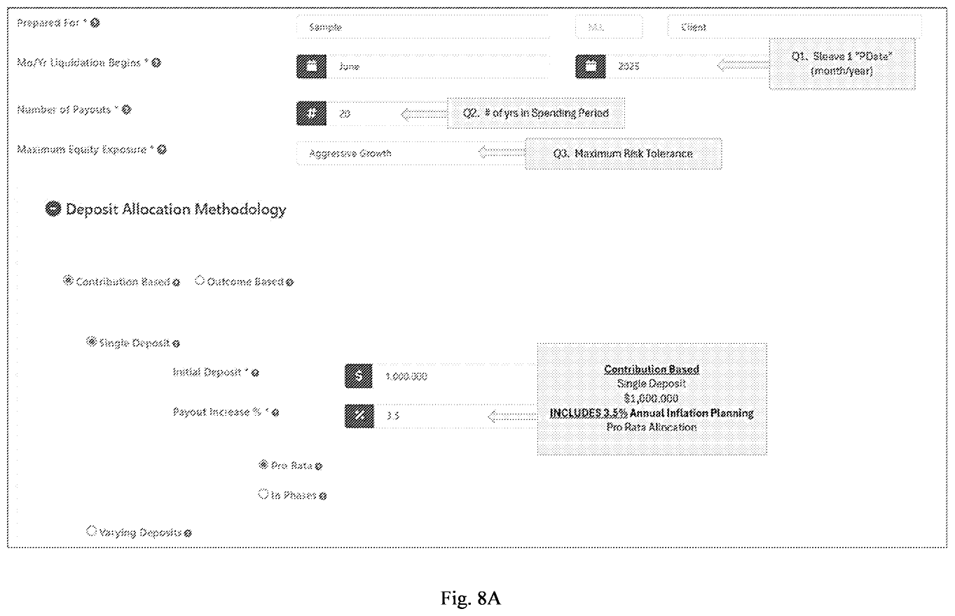

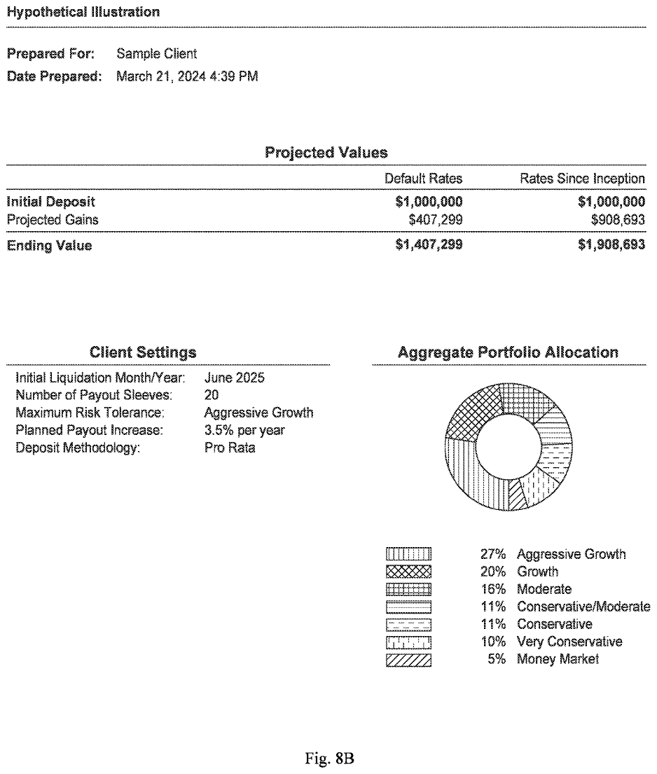

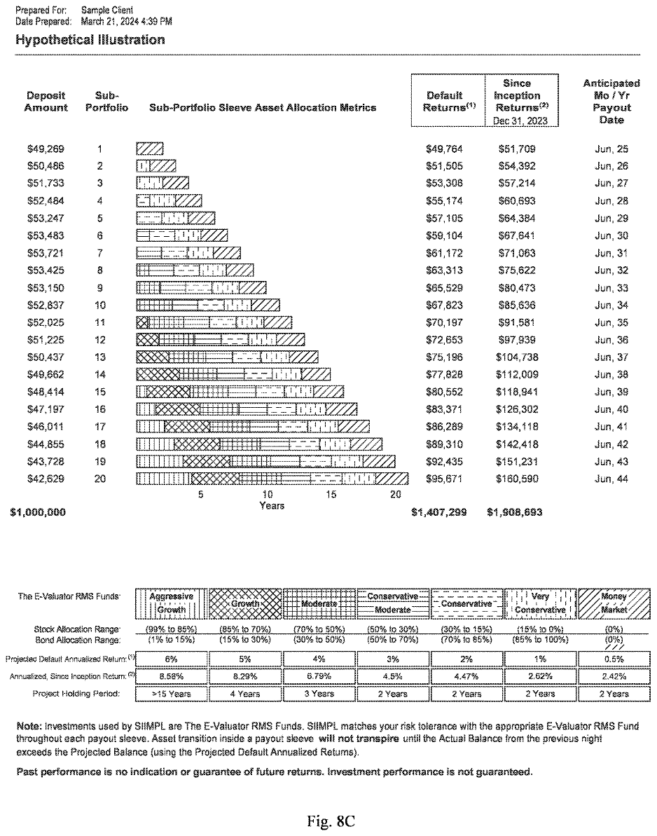

FIG. 8A depicts an input screen for an embodiment of the invention in which an initial deposit amount of one-million dollars allocated equally (“Pro Rata”) to each of 20 sleeves has been indicated. Also indicated is that the first sleeve has an ACDate of June 2025, and the maximum risk tolerance has been identified as “Aggressive Growth”. Unlike FIG. 7A, FIG. 8A indicates an offset for an inflation rate of 3.5% is indicated. The offset is used to increase the predicted end values of each sleeve. The impact of the offset can be seen in FIG. 8C. In FIG. 8C, the column that identifies the default return, increases each year by the 3.5% offset. By further comparing the column labeled “Deposit Amount”, it will be noticed that in FIG. 7C the deposit amount remains constant at $50,000, but the deposit amount in FIG. 8C does not, and this is due to factoring in the 3.5% offset.

FIG. 8B depicts the first of two output reports generated from the information shown in FIG. 8A. FIG. 8B indicates the projected gains and ending value of the assets using a default rate and also using historical rates for the assets selected. Also indicated in FIG. 8B is the allocation of the assets to seven risk categories as of the date of this report. FIG. 8C depicts the second of two output reports generated from the information shown in FIG. 8A. FIG. 8C indicates the deposit amount and the expected resulting value for each of the 20 sleeves. Two resulting values are indicated for each sleeve, one using a default rate of return, and another using historical rates for the assets selected.

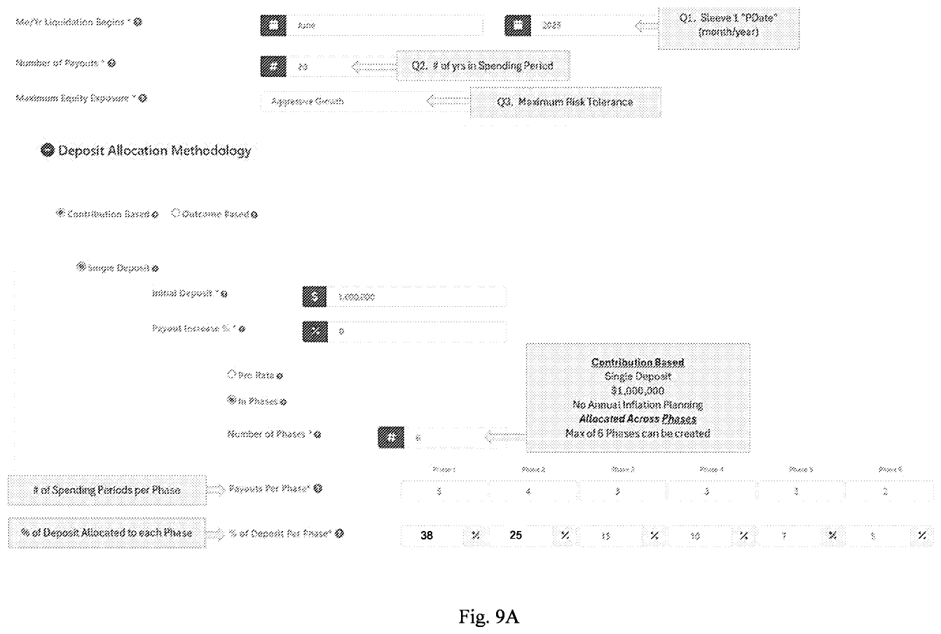

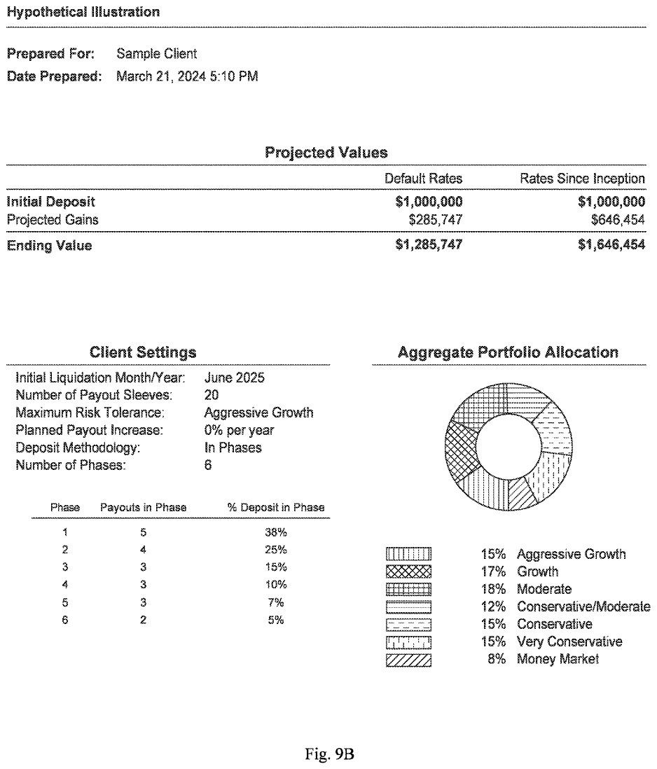

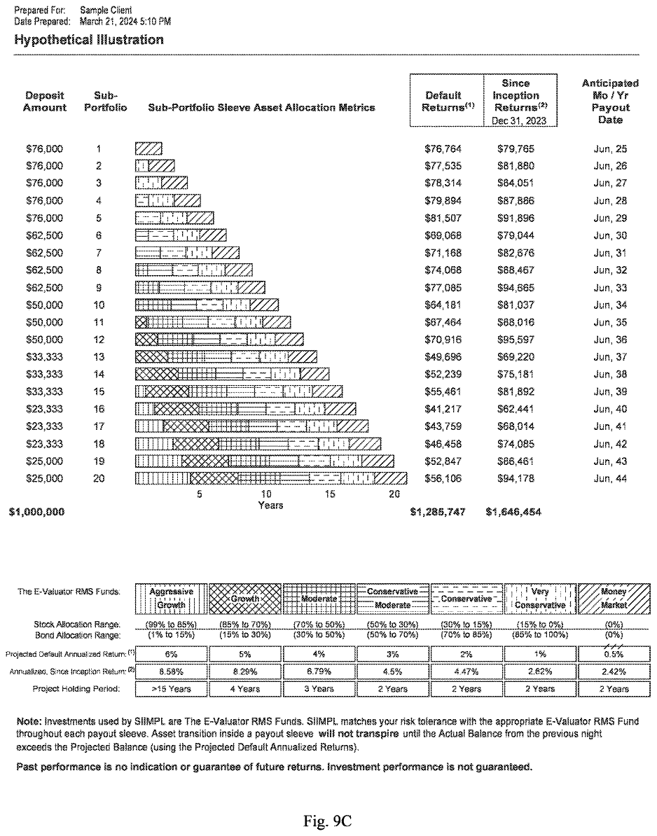

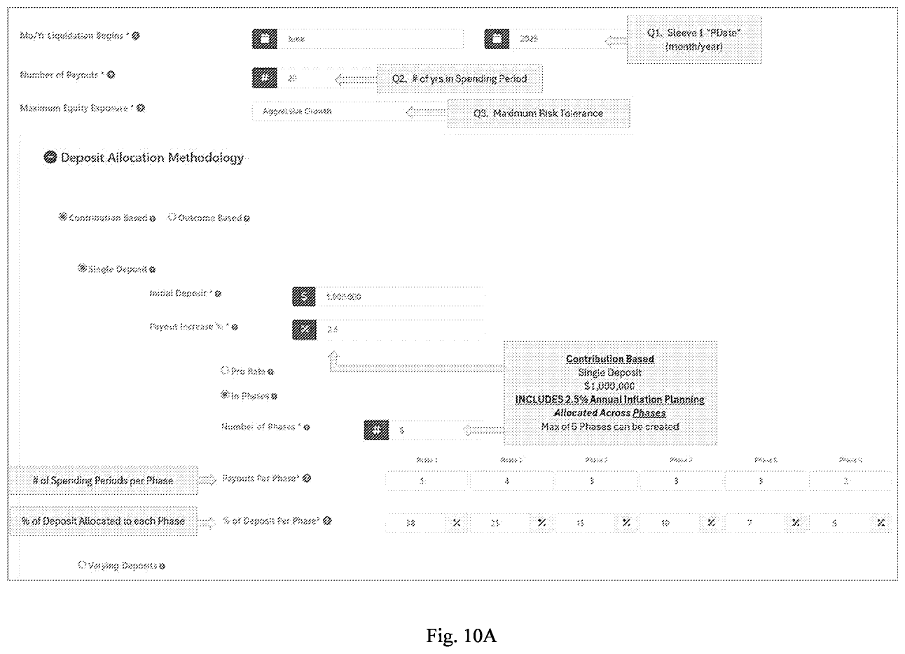

FIG. 9A depicts an input screen for an embodiment of the invention in which an initial deposit amount of one-million dollars allocated to each of 20 sleeves has been indicated, the first sleeve having an ACDate of June 2025. Also, the maximum risk tolerance has been identified as “Aggressive Growth”, and no offset for inflation is indicated. Unlike FIGS. 7A and 8A, FIG. 9A the investor would like to identify six phases corresponding to the assets she deposits. The first phase (“Phase 1”) has been indicated to comprise the first five years of the Spend Period, and 38% of the assets will be spent during Phase 1. The second phase (“Phase 2”) has been indicated to comprise the next four years of the Spend Period, and 25% of the assets will be spent during Phase 2. Phase 3 has been indicated to comprise the next three years of the Spend Period, and 15% of the assets will be spent during Phase 3. Following Phase 3, is Phase 4, which has been indicated to comprise the next three years of the Spend Period, and 10% of the assets will be spent during Phase 4. Phase 5 has been indicated to comprise the next three years of the Spend Period, and 7% of the assets will be spent during Phase 5. Finally, Phase 6 has been indicated to comprise the next two years of the Spend Period, and 5% of the assets will be spent during Phase 6.

FIG. 9B depicts the first of two output reports generated from the information shown in FIG. 9A. FIG. 9B indicates the deposit amount for each sleeve, and there one can see the six phases reflected in the deposit amounts. FIG. 9B also indicates the projected gains and ending value of the assets using a default rate and also using historical rates for the assets selected. Also indicated in FIG. 9B is the allocation of the assets to seven risk categories as of the date of this report. FIG. 9C depicts the second of two output reports generated from the information shown in FIG. 9A. FIG. 9C indicates the deposit amount and the expected resulting value for each of the 20 sleeves. Two resulting values are indicated for each sleeve, one using a default rate of return, and another using historical rates for the assets selected.

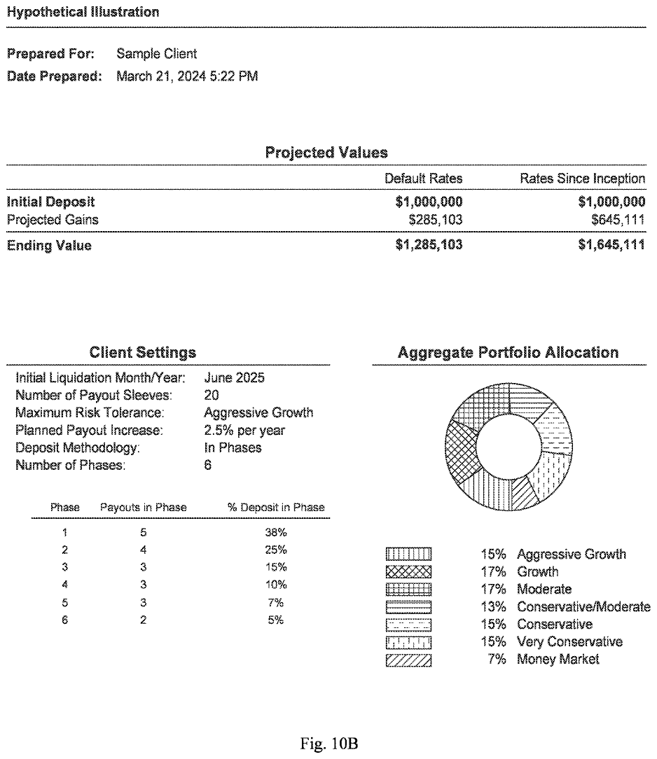

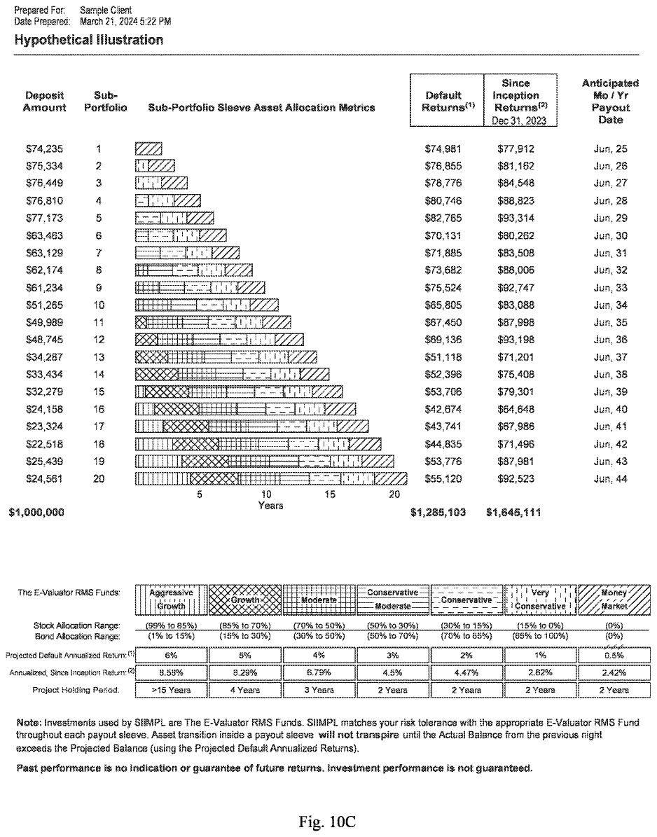

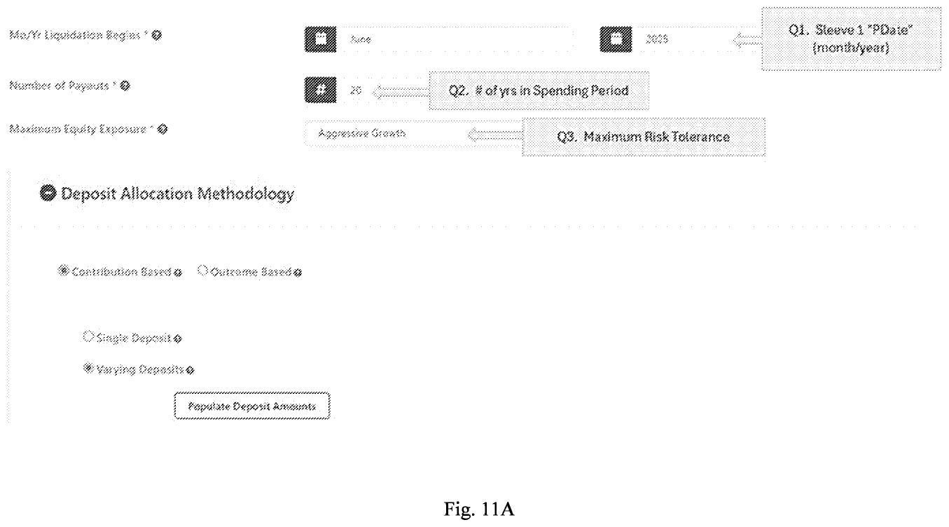

FIG. 10A depicts an input screen in which the inputs are similar to those of FIG. 9A, except the input parameters include an offset for inflation of 2.5%. FIG. 10B depicts the first of two output reports generated from the information shown in FIG. 10A. FIG. 10B indicates the deposit amount for each sleeve, and there one can see the six phases reflected in the deposit amounts. FIG. 10B also indicates the projected gains and ending value of the assets using a default rate and also using historical rates for the assets selected. Also indicated in FIG. 10B is the allocation of the assets to seven risk categories as of the date of this report. FIG. 10C depicts the second of two output reports generated from the information shown in FIG. 10A. FIG. 10C indicates the deposit amount and the expected resulting value for each of the 20 sleeves. Two resulting values are indicated for each sleeve, one using a default rate of return, and another using historical rates for the assets selected.

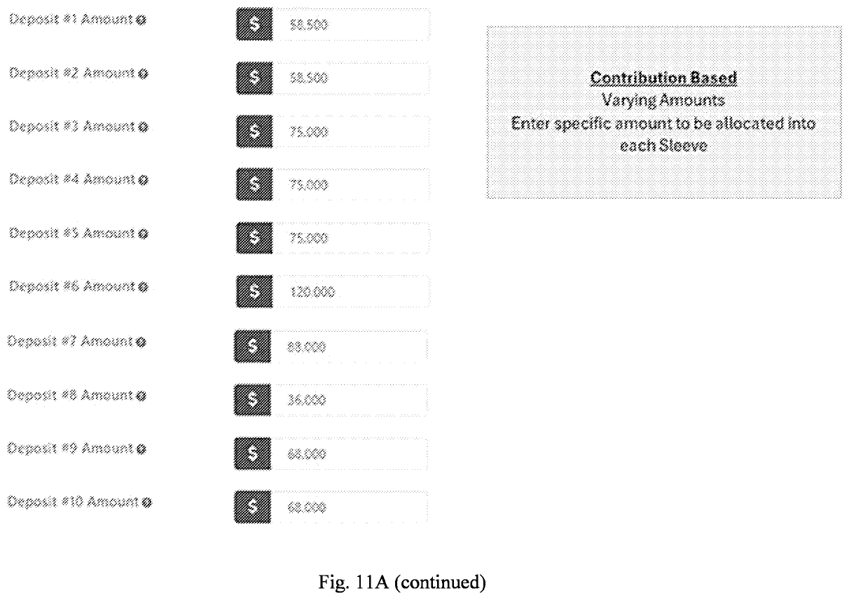

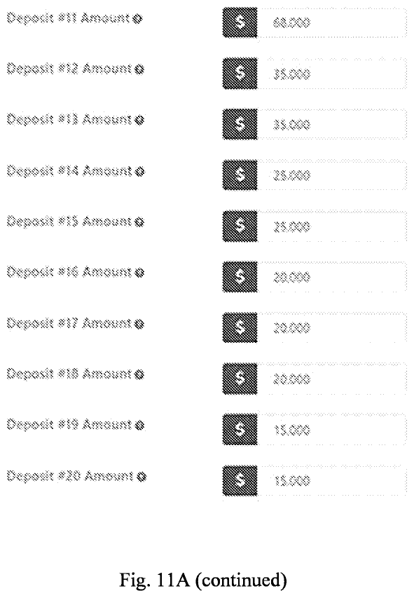

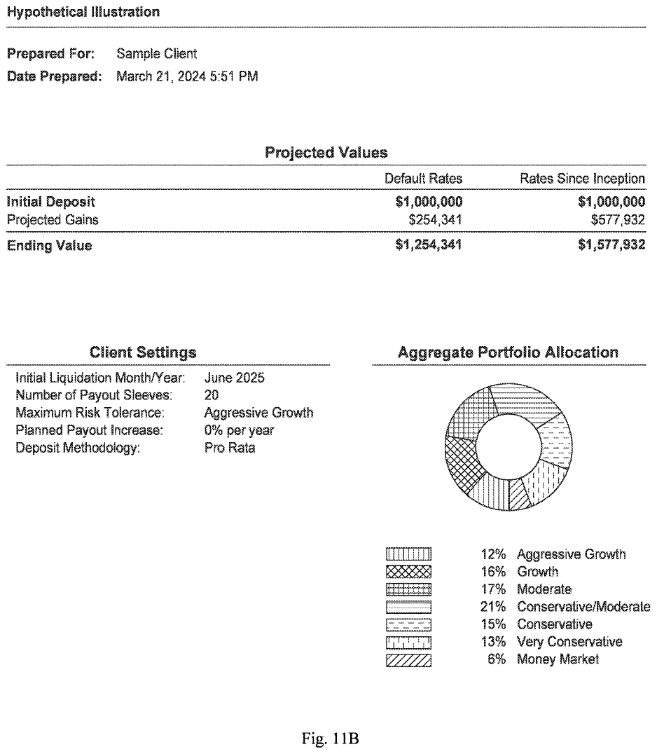

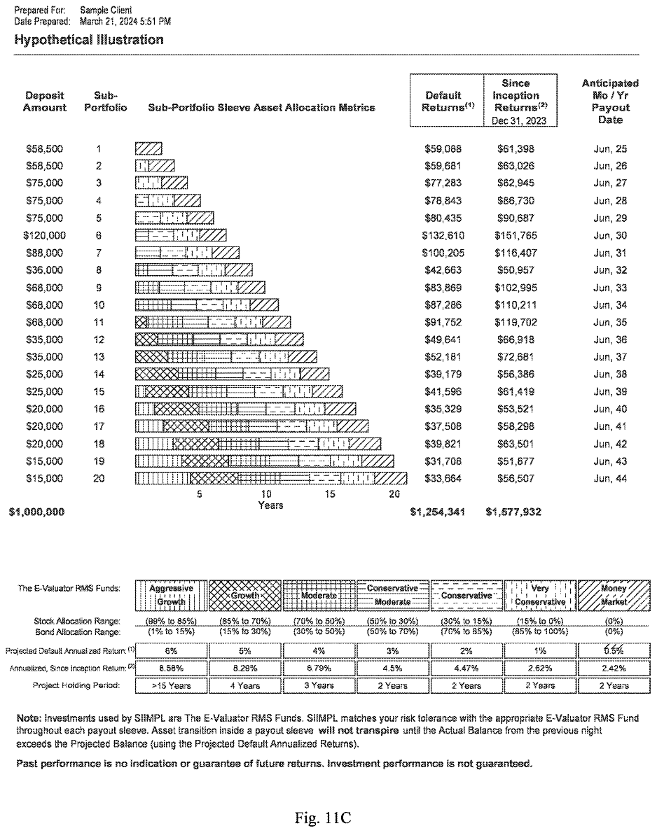

FIG. 11A1, 11A2, and 11A3 depict an input screen for an embodiment of the invention in which an initial deposit amount of one-million dollars allocated to each of 20 sleeves has been indicated. Also indicated is that the first sleeve has an ACDate of June 2025, and the maximum risk tolerance is identified as “Aggressive Growth”. No offset for inflation is indicated. The input screen of FIG. 11A1, 11A2, and 11A3 indicates “Varying Deposits” has been selected so that the amount of each deposit can be indicated separate and apart from other deposits. Affording this input option may be useful in situations where the investor's expected expenditures vary with time.

FIG. 11B depicts the first of two output reports generated from the information shown in FIG. 11A1, 11A2, and 11A3. FIG. 11B depicts the first of two output reports generated from the information shown in FIG. 11A1, 11A2, and 11A3. FIG. 11B indicates the projected gains and ending value of the assets using a default rate and also using historical rates for the assets selected. Also indicated in FIG. 11B is the allocation of the assets to seven risk categories as of the date of this report.

FIG. 11C depicts the second of two output reports generated from the information shown in FIG. 11A1, 11A2, and 11A3. FIG. 11C indicates the deposit amount and the expected resulting value for each of the 20 sleeves. Two resulting values are indicated for each sleeve, one using a default rate of return, and another using historical rates for the assets selected. The result of varying deposit amounts is reflected in the varying values of the sleeves at the ACDates.

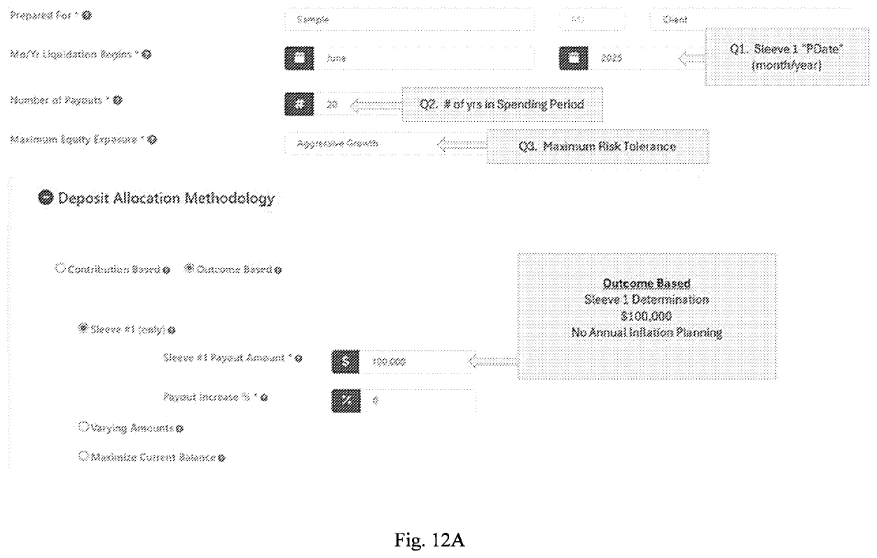

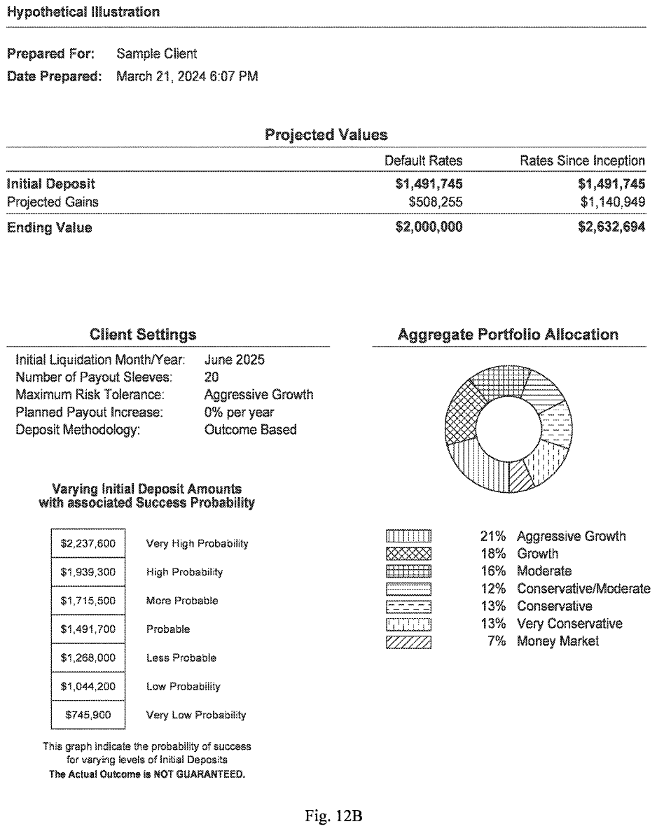

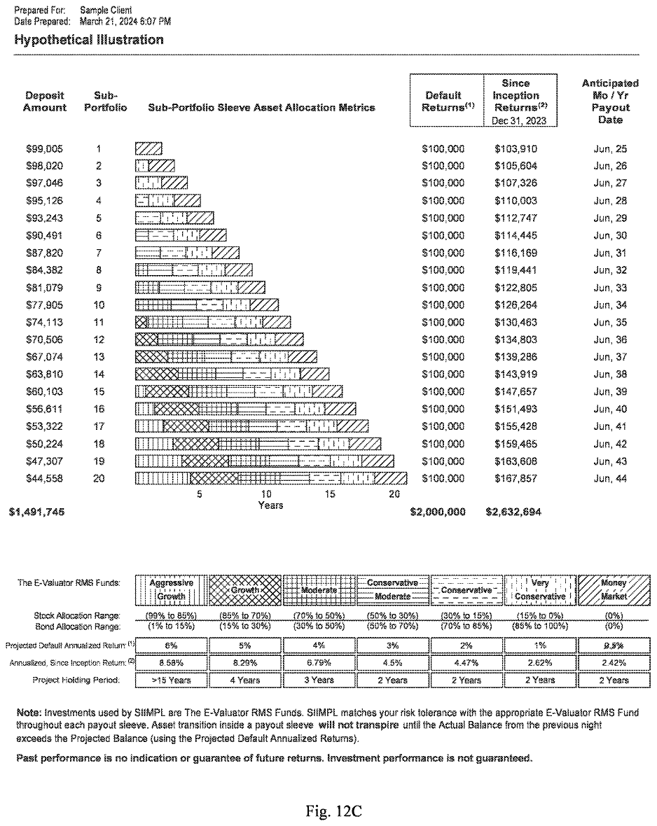

FIG. 12A depicts an input screen for an embodiment of the invention in which an ALGoal of $100,000 is indicated for each of 20 sleeves. Also indicated is that the first sleeve has an ACDate of June 2025, and the maximum risk tolerance has been identified as “Aggressive Growth”. No offset for inflation is indicated. That is to say, the ALGoal remains $100,000 for each year of the Spend Period. FIG. 12B depicts the first of two output reports generated from the information shown in FIG. 12A. FIG. 12B indicates the projected gains and ending value of the assets using a default rate and also using historical rates for the assets selected. Also indicated in FIG. 12B is the allocation of the assets to seven risk categories as of the date of this report. In addition, FIG. 12B includes information regarding the probability of achieving the investor's ALGoal of $100,000 per year. That information indicates a very high probability of achieving the ALGoal if $2,237,600 is initially invested, and a low probability if $1,044,200 is initially invested. FIG. 12C depicts the second of two output reports generated from the information shown in FIG. 12A. FIG. 12C indicates the deposit amount and the expected resulting value for each of the 20 sleeves. Two resulting values are indicated for each sleeve, one using a default rate of return, and another using historical rates for the assets selected.

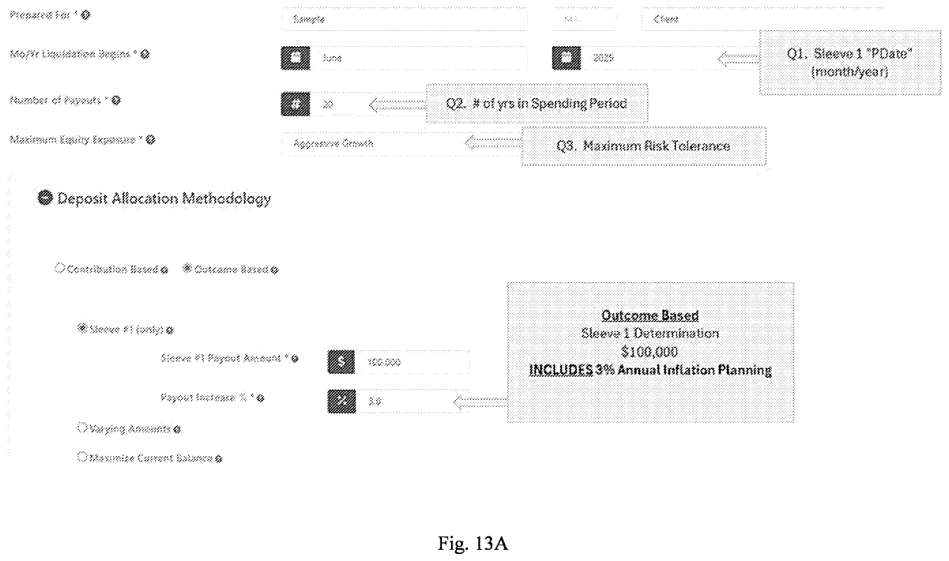

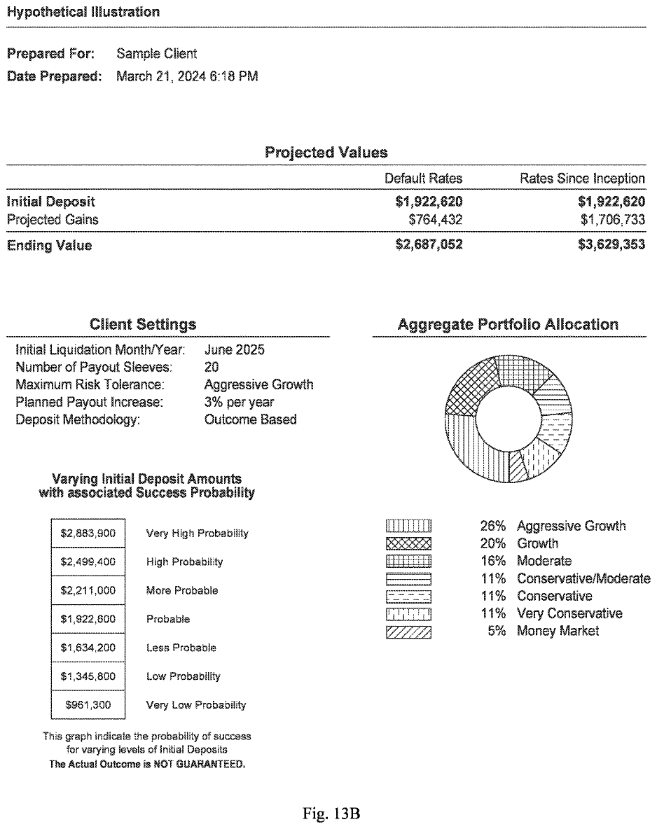

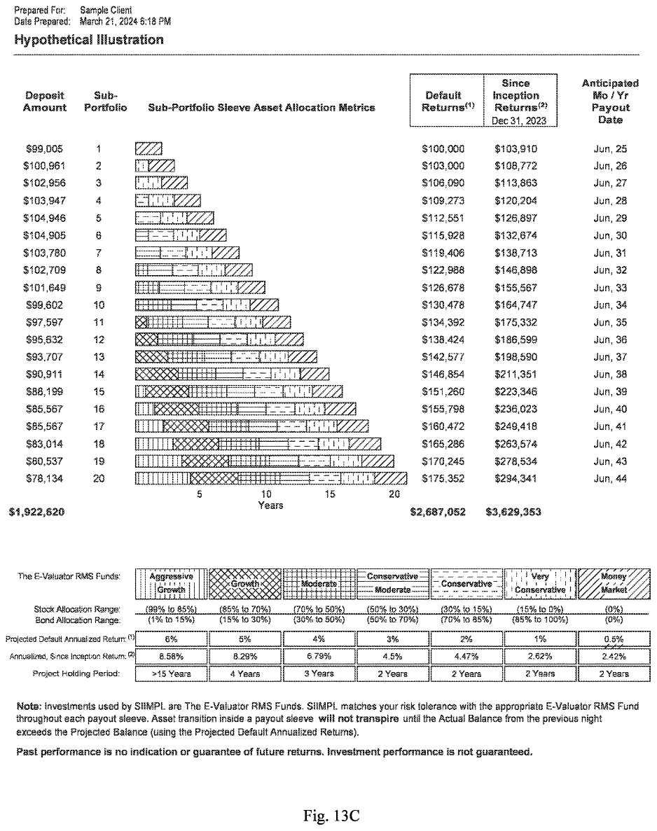

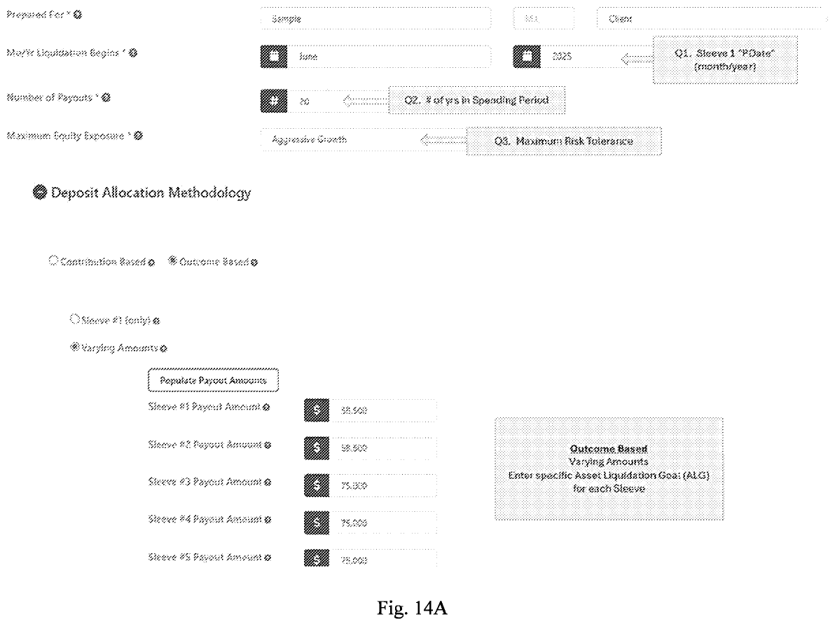

FIG. 13A depicts an input screen for an embodiment of the invention in which an ALGoal of $100,000 is indicated for each of 20 sleeves. Also indicated is that the first sleeve has an ACDate of June 2025, and the maximum risk tolerance has been identified as “Aggressive Growth”. Unlike FIG. 12A, FIG. 13A shows that an offset for an inflation rate of 3.0% is indicated. The offset is used to increase the ALGoal, and then adjust the deposit amount for each sleeve accordingly. The effect of including the offset can be seen by comparing FIG. 12C to FIG. 13C. In FIG. 12C, the ALGoal of $100,000 is reflected in the column that identifies the default return, and with no offset for inflation, the default return is constant year-to-year at $100,000. However, in FIG. 13C, the default return starts at the ALGoal of $100,000 and increases by 3% each year. In addition, the deposit amounts shown in FIG. 12C are different from those of FIG. 13C due to the inflation offset.

FIG. 13B depicts the first of two output reports generated from the information shown in FIG. 13A. FIG. 13B indicates the projected gains and ending value of the assets using a default rate and also using historical rates for the assets selected. Also indicated in FIG. 13B is the allocation of the assets to seven risk categories as of the date of this report. In addition, FIG. 13B includes information regarding the probability of achieving the investor's ALGoal of $100,000 per year with the 3% offset for inflation factored in. That information indicates a high probability of achieving the ALGoal if $2,499,400 is initially invested, and a very low probability if $961,300 is initially invested. FIG. 13C depicts the second of two output reports generated from the information shown in FIG. 13A. FIG. 13C indicates the deposit amount and the expected resulting value for each of the 20 sleeves. Two resulting values are indicated for each sleeve, one using a default rate of return, and another using historical rates for the assets selected.

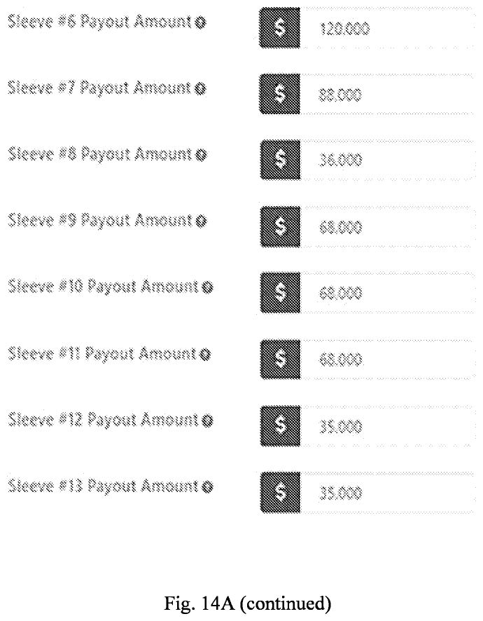

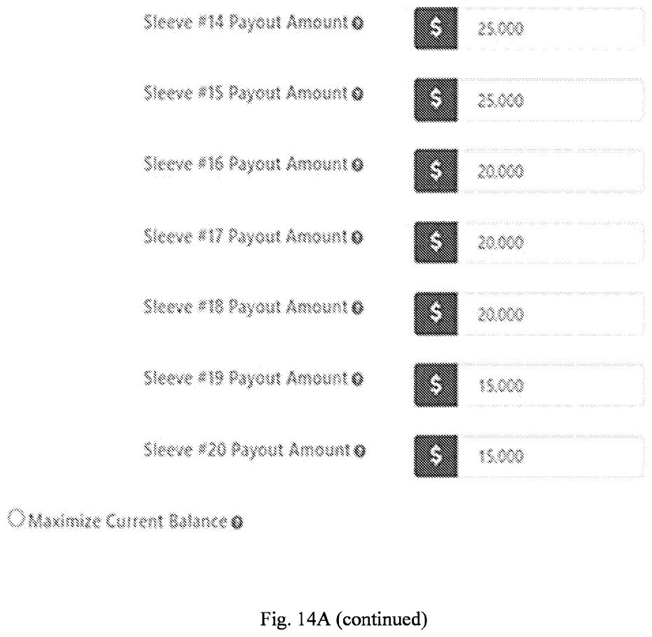

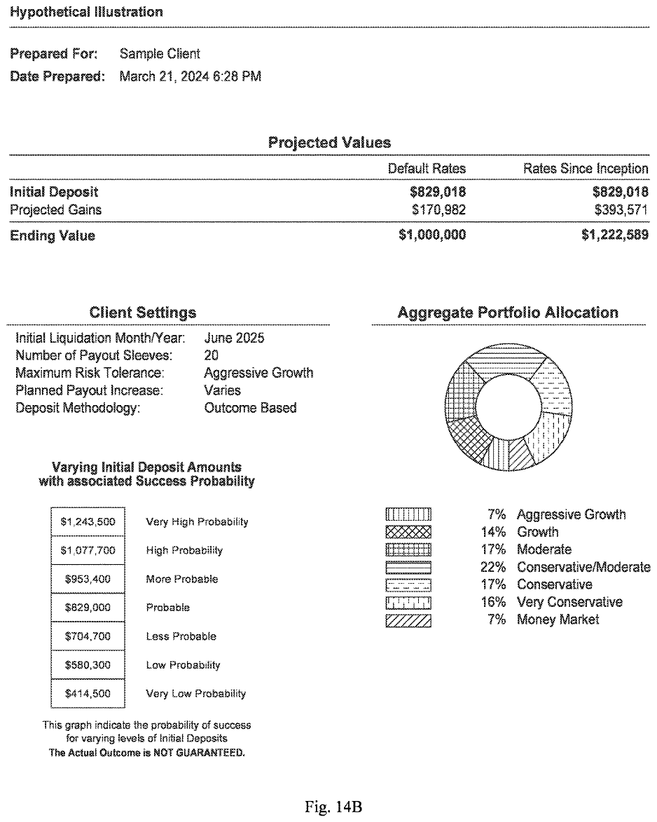

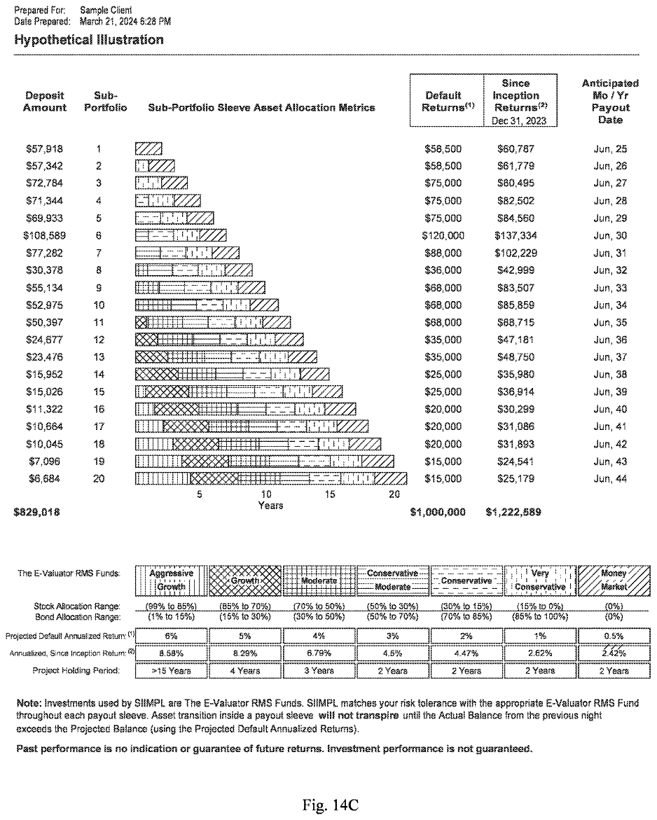

FIG. 14A1, 14A2, and 14A3 depict an input screen for an embodiment of the invention in which an ALGoal for each of 20 sleeves has been entered, the first sleeve having an ACDate of June 2025. Also, the maximum risk tolerance has been identified as “Aggressive Growth”, and no offset for inflation is indicated. The input screen of FIG. 14A1, 14A2, and 14A3 indicates “Varying Amounts” has been selected so that the ALGoal of each sleeve can be indicated separate and apart from other ALGoals. Affording this input option may be useful in situations where the investor's expected expenditures vary with time.

FIG. 14B depicts the first of two output reports generated from the information shown in FIG. 14A1, 14A2, and 14A3. FIG. 14B indicates the projected gains and ending value of the assets using a default rate and also using historical rates for the assets selected. Also indicated in FIG. 14B is the allocation of the assets to seven risk categories as of the date of this report. In addition, FIG. 14B includes information regarding the probability of achieving the ALGoals if the specified deposit amount is initially invested. That information indicates a high probability of achieving the ALGoals if $1,077,700 is initially invested, and a very low probability if $414,500 is initially invested. FIG. 14C depicts the second of two output reports generated from the information shown in FIG. 14A1, 14A2, and 14A3. FIG. 14C indicates the deposit amount corresponding to each ALGoal for each of the 20 sleeves. Two resulting values are indicated for each sleeve, one using a default rate of return, and another using historical rates for the assets selected.

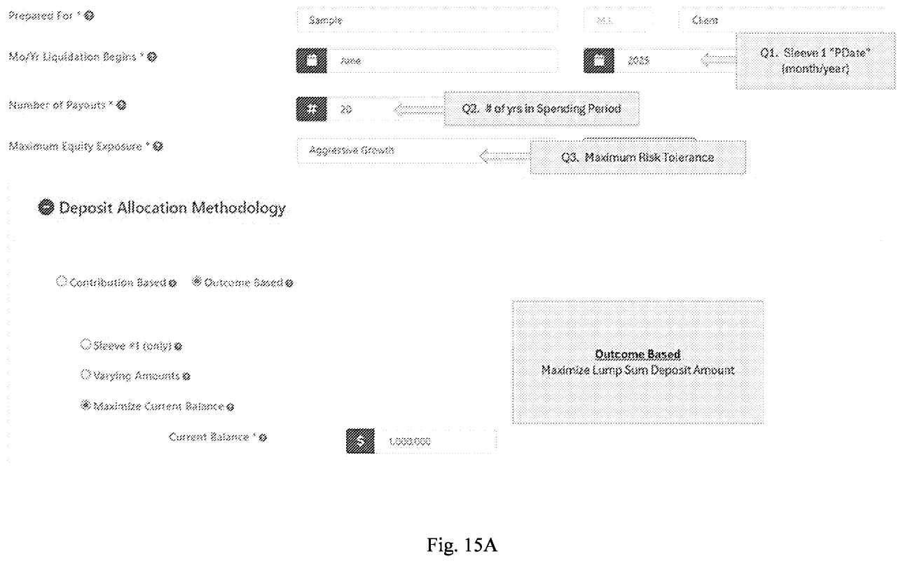

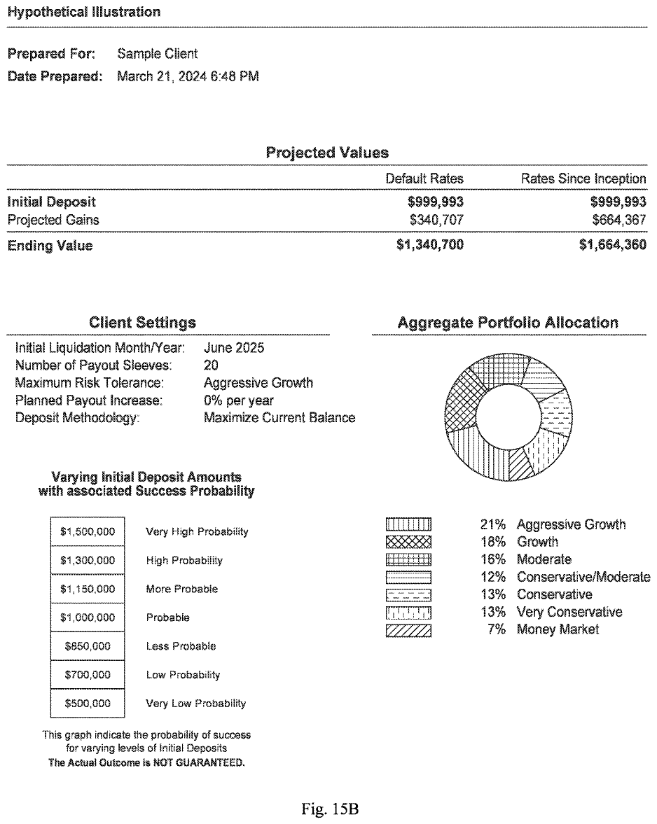

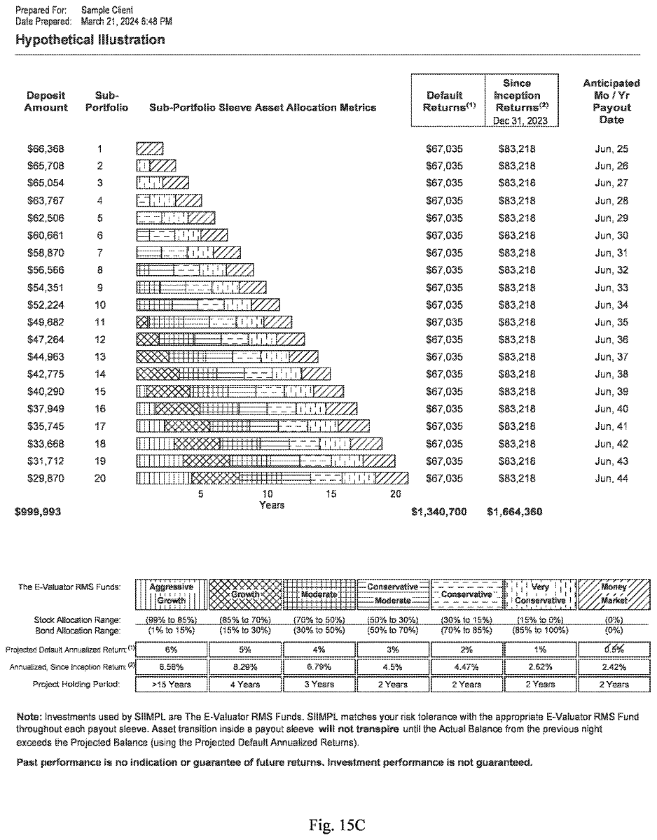

FIG. 15A depicts an input screen for an embodiment of the invention in which the investor has $1,000,000 to invest, and would like to allocate that $1,000,000 so that each of 20 sleeves produces the same amount on its ACDate. In this example, FIG. 15A indicates the “Maximize Current Balance” has been selected, and in doing so, the investor has indicated she would like to know the maximum amount that can be realized from the one million dollar initial investment, assuming the ALGoal of each sleeve is the same.² Also indicated is a tolerance identified as “Aggressive Growth”. No offset for inflation is indicated in FIG. 15A.

FIG. 15B depicts the first of two output screens generated from the information shown in FIG. 15A. FIG. 15B indicates the projected gains and ending value of the assets using a default rate and also using historical rates for the assets selected. Also indicated in FIG. 15B is the allocation of the assets to seven risk categories as of the date of this report. In addition, FIG. 15B includes information regarding the probability of achieving the ALGoals if the specified deposit amount is initially invested. That information indicates a high probability of achieving the ALGoals if $1,300,000 is initially invested, and a low probability if $700,000 is initially invested. FIG. 15C depicts the second of two output reports generated from the information shown in FIG. 15A. FIG. 15C indicates the deposit amount corresponding to each ALGoal, which has been determined to be $67,035, for each of the 20 sleeves. Two resulting values are indicated for each sleeve, one using a default rate of return, and another using historical rates for the assets selected.

Now that features of the invention and some embodiments of the invention have been described, an outline (non-limiting) of various embodiments of the invention is stated as follows:

Statement A1. An asset management system for managing assets of an investor, the asset management system comprising:
an investor information database (“IIDatabase”) for storing information about an investor;
a processing apparatus comprising at least one non-transitory memory having computer-executable program code instructions stored thereon, and at least one processor capable of executing the program code instructions, wherein the processor, the at least one non-transitory memory, and the program code instructions are configured to cause the processing apparatus to:
   (A) receive information about the investor (“Investor Information”), including a conversion start date (“CSDate”) and a spend period;
      the CSDate being a date on which the investor would like to begin converting assets, which are managed by the management system, to liquid or near-liquid ² How is the highest possible amount determined?assets, and
      the spend period being a period of time starting on the CSDate and ending on a date that is later than the CSDate during which the investor would like assets to be available for conversion to the liquid or near-liquid assets;
   (b) store the investor information in the IIDatabase;
   (C) divide the spend-period into time-subsets;
   (D) for each time-subset:
      (i) identify an anticipated conversion date (“ACDate”), the ACDate being a date during the time-subset when assets associated with the time-subset are expected to be converted to the liquid or near-liquid assets;
      (ii) determine an amount of time between a current date and the ACDate (“Temporal Distance”);
      (iii) select a first risk value that is correlated to the determined Temporal Distance;
      (iv) identify an initial asset value (“IAValue”);
      (v) identify a first group of assets having the selected first risk value and the identified IAValue;
   (E) provide instructions to acquire assets;
   (F) allocate the acquired assets to sleeves of assets (each, a “Sleeve”), each Sleeve:
      (i) having the characteristics of one of the first groups; and
      (ii) being associated with the ACDate and time-subset corresponding to the one of the first groups;
   (G) identify an adjustment date on which the assets of at least one of the Sleeves will be evaluated for adjustment, and on the adjustment date for the Sleeve to be adjusted:
      (i) determine a new Temporal Distance for the time-subset corresponding to the Sleeve to be adjusted;
      (ii) select a new risk value (“New Risk Value”) for the time-subset corresponding to the Sleeve to be adjusted, the New Risk Value being correlated to the new Temporal Distance;
      (iii) identify a second group of assets having the New Risk Value and an equivalent value of the Sleeve to be adjusted;
      (iv) provide instructions to acquire the second group of assets;
      (v) associate the acquired second group of assets with the Sleeve to be adjusted, and disassociate the first group of assets from the Sleeve to be adjusted;
   (H) for each Sleeve, on or near the ACDate for that Sleeve, identify the second group of assets allocated to that Sleeve for conversion to a liquid or near-liquid asset.
Statement A2. The system of Statement A1, wherein the processor, the at least one non-transitory memory, and the program code instructions are configured to cause the processing apparatus to:
   (A) receive a maximum risk tolerance of the investor;
   (B) prior to identifying the first groups, modify the selected risk values that are higher than the maximum risk tolerance so that the selected risk values are not higher than the maximum risk tolerance.
Statement A3. The system of Statement A1 or A2, wherein the processor, the at least one non-transitory memory, and the program code instructions are configured to cause the processing apparatus to:
   (A) receive a maximum risk tolerance of the investor;
   (B) prior to identifying the second groups, modify the New Risk Values that are higher than the maximum risk tolerance so that the New Risk Values are not higher than the maximum risk tolerance.
Statement A4. The system of Statement A1, A2, or A3 wherein each risk value is correlated with a range of time, and selection of the risk value is carried out by determining which of the ranges the Temporal Distance falls within.
Statement A5. The system of Statement A4, wherein the ranges are set so that risk values that are high are correlated with ranges having times that are distant in the future relative to ranges correlated to low risk values, and risk values that are low are correlated with ranges having times that are not distant in the future relative to ranges correlated to high risk values.
Statement A6. The system of any of the preceding Statements, further comprising an asset definition database for storing information about assets that may be acquired, wherein the information about assets includes risk information for each of the assets that may be acquired.
Statement A7. The system of any of the preceding Statements, wherein the IAValue is a present value of an asset liquidation goal (“ALGoal”), the ALGoal being a desired value of assets associated with a time-subset when the ACDate of that time-subset is reached.
Statement A8. The system of Statement A7, wherein each risk value is associated with an anticipated rate-of-return, and the present value of the ALGoal is determined by taking into account the anticipated rate-of-return for the risk value and the New Risk Value of the time-subset.
Statement A9. The system of any of the preceding Statements, further comprising an acquired-asset information database for storing information about the acquired assets.
Statement A10. The system of any of the preceding Statements, wherein the risk value is high if the asset is considered likely to have large changes in value over a time period.
Statement A11. The system of any of the preceding Statements, wherein the risk value is low if the asset is considered likely to have small changes in value over a time period.
Statement A12. The system of any of the preceding A Statements, wherein the computer-executable program code instructions further include instructions that are capable of causing the processor, on the adjustment date, to determine whether the first group of assets of the Sleeve achieved an expected growth, and delay executing step “G” if the first group of assets of the Sleeve did not achieve the expected growth.
Statement B13. A computer program product for managing assets, the computer program product comprising at least one non-transitory computer-readable storage medium having computer-executable program code instructions stored therein, the computer-executable program code instructions comprising program code instructions capable of causing a processing apparatus having at least one processor capable of executing the program code instructions to:
   (A) receive information about the investor (“Investor Information”), including a conversion start date (“CSDate”) and a spend period;
      the CSDate being a date on which the investor would like to begin converting assets, which are managed by using the computer program product, to liquid or near-liquid assets, and
      the spend period being a period of time starting on the CSDate and ending on a date that is later than the CSDate during which the investor would like assets to be available for conversion to the liquid or near-liquid assets;
   (B) store the Investor Information in an investor information database;
   (C) divide the spend-period into time-subsets;
   (D) for each time-subset:
      (i) identify an anticipated conversion date (“ACDate”), the ACDate being a date during the time-subset when assets associated with the time-subset are expected to be converted to the liquid or near-liquid assets;
      (ii) determine an amount of time between a current date and the ACDate (“Temporal Distance”);
      (iii) select a first risk value that is correlated to the determined Temporal Distance;
      (iv) identify an initial asset value (“IA Value”);
      (v) identify a first group of assets having the selected first risk value and the identified IA Value;
   (E) provide instructions to acquire assets;
   (F) allocate the acquired assets to sleeves of assets (each, a “Sleeve”), each Sleeve:
      (i) having the characteristics of one of the first groups; and
      (ii) being associated with the ACDate and time-subset corresponding to the one of the first groups;
   (G) identify an adjustment date on which the assets of at least one of the Sleeves will be evaluated for adjustment, and on the adjustment date for the Sleeve to be adjusted:
      (i) determine a new Temporal Distance for the time-subset corresponding to the Sleeve to be adjusted;
      (ii) select a new risk value (“New Risk Value”) for the time-subset corresponding to the Sleeve to be adjusted, the New Risk Value being correlated to the new Temporal Distance;
      (iii) identify a second group of assets having the New Risk Value and an equivalent value of the Sleeve to be adjusted;
      (iv) provide instructions to acquire the second group of assets;
      (v) associate the acquired second group of assets with the Sleeve to be adjusted, and disassociate the first group of assets from the Sleeve to be adjusted;
   (H) for each Sleeve, on or near the ACDate for that Sleeve, identify the second group of assets associated with that Sleeve for conversion to a liquid or near-liquid asset.
Statement B14. The computer program product of Statement B13, wherein the processor, the at least one non-transitory memory, and the program code instructions are configured to cause the processing apparatus to:
   (A) receive a maximum risk tolerance of the investor;
   (B) prior to identifying the first groups, modify the selected risk values that are higher than the maximum risk tolerance so that the selected risk values are not higher than the maximum risk tolerance.
Statement B15. The computer program product of Statement B13, wherein the processor, the at least one non-transitory memory, and the program code instructions are configured to cause the processing apparatus to:
(A) receive a maximum risk tolerance of the investor;
   (B) prior to identifying the second groups, modify the New Risk Values that are higher than the maximum risk tolerance so that the New Risk Values are not higher than the maximum risk tolerance.
Statement B16. The computer program product of Statement B13, B14, or B15, wherein each risk value is correlated with a range of time, and selection of the risk value is carried out by determining which of the ranges the Temporal Distance falls within.
Statement B17. The computer program product of Statement B16, wherein the ranges are set so that risk values that are high are correlated with ranges having times that are distant in the future relative to ranges correlated to low risk values, and risk values that are low are correlated with ranges having times that are not distant in the future relative to ranges correlated to high risk values.
Statement B18. The computer program product of any of the preceding B Statements, further comprising computer-executable program code instructions capable of causing the processor to access an asset definition database that stores information about assets that may be acquired, wherein the information about assets includes risk information for each of the assets that may be acquired.
Statement B19. The computer program product of any of the preceding B Statements, wherein the IAValue is a present value of an asset liquidation goal (“ALGoal”), the ALGoal being a desired value of assets associated with a time-subset when the ACDate of that time-subset is reached.
Statement B20. The computer program product of Statement B19, wherein each risk value is associated with an anticipated rate-of-return, and the present value of the ALGoal is determined by taking into account the anticipated rate-of-return for the risk value and the New Risk Value of the time-subset.
Statement B21. The computer program product of any of the preceding B Statements, further comprising computer-executable program code instructions capable of causing the processor to send acquired-asset information to a database for storing information about the acquired assets.
Statement B22. The computer program product of any of the preceding B Statements, wherein the risk value is high if the asset is considered likely to have large changes in value over a time period.
Statement B23. The computer program product of any of the preceding B Statements, wherein the risk value is low if the asset is considered likely to have small changes in value over a time period.
Statement B24. The computer program product of any of the preceding B Statements, wherein on the adjustment date, determine whether the first group of assets of the Sleeve achieved an expected growth, and delay executing step “G” if the first group of assets of the Sleeve did not achieve the expected growth.
Statement C25. A computer-implemented method for managing assets, comprising:
   providing an investor information database (“IIDatabase”) for storing information about an investor;
   providing a processing apparatus comprising at least one non-transitory memory having computer-executable program code instructions stored thereon, and at least one processor capable of executing the program code instructions;
   using the processor, the at least one non-transitory memory, and the program code instructions, causing the processing apparatus to:
      (A) receive information about the investor (“Investor Information”), including a conversion start date (“CSDate”) and a spend period;
         the CSDate being a date on which the investor would like to begin converting assets, which are managed by executing the computer-implemented method, to liquid or near-liquid assets, and
         the spend period being a period of time starting on the CSDate and ending on a date that is later than the CSDate during which the investor would like assets to be available for conversion to the liquid or near-liquid assets;
      (B) store the Investor Information in the IIDatabase;
      (C) divide the spend-period into time-subsets;
      (D) for each time-subset:
         (i) identify an anticipated conversion date (“ACDate”), the ACDate being a date during the time-subset when assets associated with the time-subset are expected to be converted to the liquid or near-liquid assets;
         (ii) determine an amount of time between a current date and the ACDate (“Temporal Distance”)
         (iii) for each time-subset, select a first risk value that is correlated to the determined Temporal Distance;
         (iv) for each time-subset, identify an initial asset value (“IAValue”);
         (v) for each time-subset, identify a first group of assets having the selected first risk value and the identified IAValue;
      (E) provide instructions to acquire assets;
      (F) allocate the acquired assets to sleeves of assets (each, a “Sleeve”), each Sleeve:
         (i) having the characteristics of one of the first groups; and
         (ii) being associated with the ACDate and time-subset corresponding to the one of the first groups;
      (G) identify an adjustment date on which the assets of at least one of the Sleeves will be evaluated for adjustment, and on the adjustment date for the Sleeve to be adjusted:
         (i) determine a new Temporal Distance for the time-subset corresponding to the Sleeve to be adjusted;
         (ii) select a new risk value (“New Risk Value”) for the time-subset corresponding to the Sleeve to be adjusted, the New Risk Value being correlated to the new Temporal Distance;
         (iii) identify a second group of assets having the New Risk Value and an equivalent value of the Sleeve to be adjusted;
         (iv) provide instructions to acquire the second group of assets;
         (v) associate the acquired second group of assets with the Sleeve to be adjusted, and disassociate the first group of assets from the Sleeve to be adjusted;
      (H) for each Sleeve, on or near the ACDate for that Sleeve, identify the second group of assets associated with that Sleeve for conversion to a liquid or near-liquid asset.
Statement C26. The computer-implemented method of Statement C25, wherein the processor, the at least one non-transitory memory, and the program code instructions are configured to cause the processing apparatus to:
   (a) receive a maximum risk tolerance of the investor;
   (b) prior to identifying the first groups, modify the selected risk values that are higher than the maximum risk tolerance so that the selected risk values are not higher than the maximum risk tolerance.
Statement C27. The computer-implemented method of Statement C25, wherein the processor, the at least one non-transitory memory, and the program code instructions are configured to cause the processing apparatus to:
   (a) receive a maximum risk tolerance of the investor;
   (b) prior to identifying the second groups, modify the New Risk Values that are higher than the maximum risk tolerance so that the New Risk Values are not higher than the maximum risk tolerance.
Statement C28. The computer-implemented method of Statement C25, C26, or C27, wherein each risk value is correlated with a range of time, and selection of the risk value is carried out by determining which of the ranges the Temporal Distance falls within.
Statement C29. The computer-implemented method of Statement C28, wherein the ranges are set so that risk values that are high are correlated with ranges having times that are distant in the future relative to ranges correlated to low risk values, and risk values that are low are correlated with ranges having times that are not distant in the future relative to ranges correlated to high risk values.
Statement C30. The computer-implemented method of any of the preceding C Statements, further comprising accessing an asset definition database storing information about assets that may be acquired, wherein the information about assets includes risk information for each of the assets that may be acquired.
Statement C31. The computer-implemented method of any of the preceding C Statements, wherein the IAValue is a present value of an asset liquidation goal (“ALGoal”), the ALGoal being a desired value of assets associated with a time-subset when the ACDate of that time-subset is reached.
Statement C32. The computer-implemented method of Statement C31, wherein each risk value is associated with an anticipated rate-of-return, and the present value of the ALGoal is determined by taking into account the anticipated rate-of-return for the risk value and the New Risk Value of the time-subset.
Statement C33. The computer-implemented method of any of the preceding C Statements, further comprising an acquired-asset information database for storing information about the acquired assets.
Statement C34. The computer-implemented method of any of the preceding C Statements, wherein the risk value is high if the asset is considered likely to have large changes in value over a time period.
Statement C35. The computer-implemented method of any of the preceding C Statements, wherein the risk value is low if the asset is considered likely to have small changes in value over a time period.
Statement C36. The computer-implemented method of any of the preceding C Statements, wherein on the adjustment date, determine whether the first group of assets of the Sleeve achieved an expected growth, and delay executing step “G” if the first group of assets of the Sleeve did not achieve the expected growth.

### Conclusion

The invention may be carried out so as to alleviate some of the shortcomings of existing TDFunds. Unlike existing TDFunds that are structured around five-year increments, if an investor wants to retire or initiate conversion of his/her assets over time to liquid or near-liquid assets starting on a particular date, a method according to the invention may be carried out so as to manage the investor's assets to the Conversion Start Date, and every ACDate thereafter so as to closely match that investor's financial needs and risk tolerance over time, as well as being able to take into account a stated ALGoal for assets associated with each sleeve. Likewise, instead of having all of the investor's assets exposed to the same asset allocation upon reaching a target date, a method according to the invention may be carried out so as to adjust each payout sleeve based on the amount of time until conversion while aggregating and compiling the underlying asset allocations for each sleeve into one Aggregate Portfolio. On or close to the ACDate for a particular sleeve, the assets of that sleeve may be converted to liquid or near-liquid assets so as to significantly reduce or eliminate a risk of volatility that normally accompanies many types of assets, and in that manner those converted assets could have very little to no exposure to risk of loss in value, while other assets that are not intended to be spent in the near future may have a higher rate-of-return (and the commensurate exposure to risk), thereby keeping an investor's assets growing for a longer period of time than is currently the case with TDFunds.

Although the present invention has been described with respect to one or more particular embodiments, it is to be understood that other embodiments of the present invention may be made without departing from the spirit and scope of the present invention. Hence, the present invention is deemed limited only by the appended claims and the reasonable interpretation thereof.

What is claimed is:

1. An asset management system for managing assets of an investor, the asset management system comprising:
an investor information database (“IIDatabase”) for storing information about an investor;
a processing apparatus comprising at least one non-transitory memory having computer-executable program code instructions stored thereon, and at least one processor capable of executing the program code instructions, wherein the processor, the at least one non-transitory memory, and the program code instructions are configured to cause the processing apparatus to:
(A) receive information about the investor (“Investor Information”), including a conversion start date (“CSDate”) and a spend period;
the CSDate being a date on which the investor would like to begin converting assets, which are managed by the management system, to liquid or near-liquid assets, and
the spend period being a period of time starting on the CSDate and ending on a date that is later than the CSDate during which the investor would like assets to be available for conversion to the liquid or near-liquid assets;
(B) store the Investor Information in the IIDatabase;
(C) divide the spend-period into time-subsets;
(D) for each time-subset:
(i) identify an anticipated conversion date (“ACDate”), the ACDate being a date during the time-subset when assets associated with the time-subset are expected to be converted to the liquid or near-liquid assets;
(ii) determine an amount of time between a current date and the ACDate (“Temporal Distance”);
(iii) select a first risk value that is correlated to the determined Temporal Distance;
(iv) identify an initial asset value (“IA Value”);
(v) identify a first group of assets having the selected first risk value and the identified IA Value;
(E) provide instructions to acquire assets;
(F) allocate the acquired assets to sleeves of assets (each, a “Sleeve”), each Sleeve:
(i) having the characteristics of one of the first groups; and
(ii) being associated with the ACDate and time-subset corresponding to the one of the first groups;
(G) identify an adjustment date on which the assets of at least one of the Sleeves will be evaluated for adjustment, and on the adjustment date for the Sleeve to be adjusted:
(i) determine a new Temporal Distance for the time-subset corresponding to the Sleeve to be adjusted;
(ii) select a new risk value (“New Risk Value”) for the time-subset corresponding to the Sleeve to be adjusted, the New Risk Value being correlated to the new Temporal Distance;
(iii) identify a second group of assets having the New Risk Value and an equivalent value of the Sleeve to be adjusted;
(iv) provide instructions to acquire the second group of assets;
(v) associate the acquired second group of assets with the Sleeve to be adjusted, and disassociate the first group of assets from the Sleeve to be adjusted;
(H) for each Sleeve, on or near the ACDate for that Sleeve, identify the second group of assets associated with that Sleeve for conversion a liquid or near-liquid asset.

2. The system of claim 1, wherein the processor, the at least one non-transitory memory, and the program code instructions are configured to cause the processing apparatus to:
(A) receive a maximum risk tolerance of the investor;
(B) prior to identifying the first groups, modify the selected risk values that are higher than the maximum risk tolerance so that the selected risk values are not higher than the maximum risk tolerance.

3. The system of claim 1, wherein the processor, the at least one non-transitory memory, and the program code instructions are configured to cause the processing apparatus to:
(A) receive a maximum risk tolerance of the investor;
(B) prior to identifying the second groups, modify the New Risk Values that are higher than the maximum risk tolerance so that the New Risk Values are not higher than the maximum risk tolerance.

4. The system of claim 1, wherein each risk value is correlated with a range of time, and selection of the risk value is carried out by determining which of the ranges the Temporal Distance falls within.

5. The system of claim 4, wherein the ranges are set so that risk values that are high are correlated with ranges having times that are distant in the future relative to ranges correlated to low risk values, and risk values that are low are correlated with ranges having times that are not distant in the future relative to ranges correlated to high risk values.

6. The system of claim 1, further comprising an asset definition database for storing information about assets that may be acquired, wherein the information about assets includes risk information for each of the assets that may be acquired.

7. The system of claim 1, wherein the IAValue is a present value of an asset liquidation goal (“ALGoal”), the ALGoal being a desired value of assets associated with a time-subset when the ACDate of that time-subset is reached.

8. The system of claim 7, wherein each risk value is associated with an anticipated rate-of-return, and the present value of the ALGoal is determined by taking into account the anticipated rate-of-return for the risk value and the New Risk Value of the time-subset.

9. The system of claim 1, further comprising an acquired-asset information database for storing information about the acquired assets.

10. The system of claim 1, wherein the risk value is high if the asset is considered likely to have large changes in value over a time period.

11. The system of claim 1, wherein the risk value is low if the asset is considered likely to have small changes in value over a time period.

12. The system of claim 1, wherein the computer-executable program code instructions further include instructions that are capable of causing the processor, on the adjustment date, to determine whether the first group of assets of the Sleeve achieved an expected growth, and delay executing step “G” if the first group of assets of the Sleeve did not achieve the expected growth.

13. A computer program product for managing assets, the computer program product comprising at least one non-transitory computer-readable storage medium having computer-executable program code instructions stored therein, the computer-executable program code instructions comprising program code instructions capable of causing a processing apparatus having at least one processor capable of executing the program code instructions to:
(A) receive information about the investor (“Investor Information”), including a conversion start date (“CSDate”) and a spend period;
the CSDate being a date on which the investor would like to begin converting assets, which are managed by the using the computer program product, to liquid or near-liquid assets, and
the spend period being a period of time starting on the CSDate and ending on a date that is later than the CSDate during which the investor would like assets to be available for conversion to the liquid or near-liquid assets;
(B) store the Investor Information in an investor information database;
(C) divide the spend-period into time-subsets;
(D) for each time-subset:
(i) identify an anticipated conversion date (“ACDate”), the ACDate being a date during the time-subset when assets associated with the time-subset are expected to be converted to the liquid or near-liquid assets;
(ii) determine an amount of time between a current date and the ACDate (“Temporal Distance”);
(iii) select a first risk value that is correlated to the determined Temporal Distance;
(iv) identify an initial asset value (“IA Value”);
(v) identify a first group of assets having the selected first risk value and the identified IA Value;
(E) provide instructions to acquire assets;
(F) allocate the acquired assets to sleeves of assets (each, a “Sleeve”), each Sleeve:
(i) having the characteristics of one of the first groups; and
(ii) being associated with the ACDate and time-subset corresponding to the one of the first groups;
(G) identify an adjustment date on which the assets of at least one of the Sleeves will be evaluated for adjustment, and on the adjustment date for the Sleeve to be adjusted:
(i) determine a new Temporal Distance for the time-subset corresponding to the Sleeve to be adjusted;
(ii) select a new risk value (“New Risk Value”) for the time-subset corresponding to the Sleeve to be adjusted, the New Risk Value being correlated to the new Temporal Distance;
(iii) identify a second group of assets having the New Risk Value and an equivalent value of the Sleeve to be adjusted;
(iv) provide instructions to acquire the second group of assets;
(v) associate the acquired second group of assets with the Sleeve to be adjusted, and disassociate the first group of assets from the Sleeve to be adjusted;
(H) for each Sleeve, on or near the ACDate for that Sleeve, identify the second group of assets associated with that Sleeve for conversion to a liquid or near-liquid asset.

14. The computer program product of claim 13, wherein the processor, the at least one non-transitory memory, and the program code instructions are configured to cause the processing apparatus to:
(a) receive a maximum risk tolerance of the investor;
(b) prior to identifying the first groups, modify the selected risk values that are higher than the maximum risk tolerance so that the selected risk values are not higher than the maximum risk tolerance.

15. The computer program product of claim 13, wherein the processor, the at least one non-transitory memory, and the program code instructions are configured to cause the processing apparatus to:
(a) receive a maximum risk tolerance of the investor;
(b) prior to identifying the second groups, modify the New Risk Values that are higher than the maximum risk tolerance so that the New Risk Values are not higher than the maximum risk tolerance.

16. The computer program product of claim 13, wherein each risk value is correlated with a range of time, and selection of the risk value is carried out by determining which of the ranges the Temporal Distance falls within.

17. The computer program product of claim 16, wherein the ranges are set so that risk values that are high are correlated with ranges having times that are distant in the future relative to ranges correlated to low risk values, and risk values that are low are correlated with ranges having times that are not distant in the future relative to ranges correlated to high risk values.

18. The computer program product of claim 13, further comprising computer-executable program code instructions capable of causing the processor to access an asset definition database for storing information about assets that may be acquired, wherein the information about assets includes risk information for each of the assets that may be acquired.

19. The computer program product of claim 13, wherein the IA Value is a present value of an asset liquidation goal (“ALGoal”), the ALGoal being a desired value of assets associated with a time-subset when the ACDate of that time-subset is reached.

20. The computer program product of claim 19, wherein each risk value is associated with an anticipated rate-of-return, and the present value of the ALGoal is determined by taking into account the anticipated rate-of-return for the risk value and the New Risk Value of the time-subset.

21. The computer program product of claim 13, further comprising computer-executable program code instructions capable of causing the processor to send acquired-asset information database for storing information about the acquired assets.

22. The computer program product of claim 13, wherein the risk value is high if the asset is considered likely to have large changes in value over a time period.

23. The computer program product of claim 13, wherein the risk value is low if the asset is considered likely to have small changes in value over a time period.

24. The computer program product of claim 13, wherein on the adjustment date, determine whether the first group of assets of the Sleeve achieved an expected growth, and delay executing step “G” if the first group of assets of the Sleeve did not achieve the expected growth.

25. A computer-implemented method for managing assets, comprising:
providing an investor information database (“IIDatabase”) for storing information about an investor;
providing a processing apparatus comprising at least one non-transitory memory having computer-executable program code instructions stored thereon, and at least one processor capable of executing the program code instructions;
using the processor, the at least one non-transitory memory, and the program code instructions, causing the processing apparatus to:
(A) receive information about the investor (“Investor Information”), including a conversion start date (“CSDate”) and a spend period;
the CSDate being a date on which the investor would like to begin converting assets, which are managed by executing the computer-implemented method, to liquid or near-liquid assets, and
the spend period being a period of time starting on the CSDate and ending on a date that is later than the CSDate during which the investor would like assets to be available for conversion to the liquid or near-liquid assets;
(B) store the Investor Information in the IIDatabase;
(C) divide the spend-period into time-subsets;
(D) for each time-subset:
(i) identify an anticipated conversion date (“ACDate”), the ACDate being a date during the time-subset when assets associated with the time-subset are expected to be converted to the liquid or near-liquid assets;
(ii) determine an amount of time between a current date and the ACDate (“Temporal Distance”);
(iii) select a first risk value that is correlated to the determined Temporal Distance;
(iv) identify an initial asset value (“IA Value”);
(v) identify a first group of assets having the selected first risk value and the identified IA Value;
(E) provide instructions to acquire assets;
(F) allocate the acquired assets to sleeves of assets (each, a “Sleeve”), each Sleeve:
(i) having the characteristics of one of the first groups; and
(ii) being associated with the ACDate and time-subset corresponding to the one of the first groups;
(G) identify an adjustment date on which the assets of at least one of the Sleeves will be evaluated for adjustment, and on the adjustment date for the Sleeve to be adjusted:
(i) determine a new Temporal Distance for the time-subset corresponding to the Sleeve to be adjusted;
(ii) select a new risk value (“New Risk Value”) for the time-subset corresponding to the Sleeve to be adjusted, the New Risk Value being correlated to the new Temporal Distance;
(iii) identify a second group of assets having the New Risk Value and an equivalent value of the Sleeve to be adjusted;
(iv) provide instructions to acquire the second group of assets;
(v) associate the acquired second group of assets with the Sleeve to be adjusted, and disassociate the first group of assets from the Sleeve to be adjusted;
(H) for each Sleeve, on or near the ACDate for that Sleeve, identify the second group of assets associated with that Sleeve for conversion to a liquid or near-liquid asset.

26. The system of claim 25, wherein the processor, the at least one non-transitory memory, and the program code instructions are configured to cause the processing apparatus to:
(i) receive a maximum risk tolerance of the investor;
(ii) prior to identifying the first groups, modify the selected risk values that are higher than the maximum risk tolerance so that the selected risk values are not higher than the maximum risk tolerance.

27. The computer-implemented method of claim 25, wherein the processor, the at least one non-transitory memory, and the program code instructions are configured to cause the processing apparatus to:
(i) receive a maximum risk tolerance of the investor;
(ii) prior to identifying the second groups, modify the New Risk Values that are higher than the maximum risk tolerance so that the New Risk Values are not higher than the maximum risk tolerance.

28. The computer-implemented method of claim 25, wherein each risk value is correlated with a range of time, and selection of the risk value is carried out by determining which of the ranges the Temporal Distance falls within.

29. The computer-implemented method of claim 28, wherein the ranges are set so that risk values that are high are correlated with ranges having times that are distant in the future relative to ranges correlated to low risk values, and risk values that are low are correlated with ranges having times that are not distant in the future relative to ranges correlated to high risk values.

30. The computer-implemented method of claim 25, further comprising accessing an asset definition database storing information about assets that may be acquired, wherein the information about assets includes risk information for each of the assets that may be acquired.

31. The computer-implemented method of claim 25, wherein the IAValue is a present value of an asset liquidation goal (“ALGoal”), the ALGoal being a desired value of assets associated with a time-subset when the ACDate of that time-subset is reached.

32. The computer-implemented method of claim 31, wherein each risk value is associated with an anticipated rate-of-return, and the present value of the ALGoal is determined by taking into account the anticipated rate-of-return for the risk value and the New Risk Value of the time-subset.

33. The computer-implemented method of claim 25, further comprising an acquired-asset information database for storing information about the acquired assets.

34. The computer-implemented method of claim 25, wherein the risk value is high if the asset is considered likely to have large changes in value over a time period.

35. The computer-implemented method of claim 25, wherein the risk value is low if the asset is considered likely to have small changes in value over a time period.

36. The computer-implemented method of claim 25, wherein on the adjustment date, determine whether the first group of assets of the Sleeve achieved an expected growth, and delay executing step “G” if the first group of assets of the Sleeve did not achieve the expected growth.
